(19) United States
(12) Patent Application Publication
(10) Pub. No.: US 2010/0250340 A1
(43) Pub. Date: Sep. 30, 2010

(54) Processing and Presenting Intellectual Property and Other Information

(75) Inventors: Lewis C. Lee, Spokane, WA (US); Daniel L. Hayes, Spokane, WA (US); Brian J. Pangrle, Spokane, WA (US)

Correspondence Address: LEE & HAYES, PLLC, 601 W. RIVERSIDE AVENUE, SUITE 1400, SPOKANE, WA, 99201, US

(73) Assignee: IP Street, Inc., Spokane, WA (US)

(21) Appl. No.: 12/730,098

(22) Filed: Mar. 23, 2010

Related U.S. Application Data
(60) Provisional application No. 61/162,998, filed on Mar. 24, 2009.

(51) Int. Cl. G06F 3/048; G06F 17/30; G06Q 50/00; G06Q 40/00; G06Q 10/00; G06F 17/27

(52) U.S. Cl. 705/10; 707/769; 715/833; 707/750; 705/310; 705/36 R; 704/9; 707/E17.014; 715/810

(57) ABSTRACT

Aggregation, analysis, and presentation of IP-related information and other information in a common interface are described.

### RELATED APPLICATIONS

This application claims the benefit of U.S. Provisional Application No. 61/162,998, filed Mar. 24, 2009, which is incorporated herein by reference.

This application is also related to PCT Application No. PCT/US2008/7886, filed Oct. 3, 2008 and U.S. patent application Ser. No. 12/245,680, filed Oct. 3, 2008, both of which claim priority to U.S. Provisional Application No. 60/977,629, filed Oct. 4, 2007, and to U.S. Provisional Application No. 60/978,088, filed Oct. 5, 2007. All of these applications are hereby incorporated by reference.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Innovation is a key factor for many companies to succeed in a globally competitive world. Protection of innovation via intellectual property (IP) helps those companies convert innovation into business assets. Today, Intangible assets represent a significant share of the market capitalizations of many of the most successful and innovative companies. Yet, to the business community and many professionals who are not IP legal experts, intellectual property generally, and patents specifically, remain somewhat of a mystery to fully understand, assess, and value.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an exemplary system for acquiring and presenting information for an intellectual property document (e.g., intellectual property identification number as assigned by a government agency);

FIG. 2 shows a method for generating a document with active components;

FIG. 3 shows a method for generating a portfolio of documents with active components;

FIG. 4 shows options for generating an active document;

FIG. 5 shows an exemplary method for displaying and controlling an active document;

FIG. 6 shows an exemplary method for generating a word cloud with features that correspond to aspects of a patent application or a patent;

FIG. 7 shows an exemplary word cloud and an exemplary scale that assigns a feature of the word cloud to a quality indicator of a patent application or a patent;

FIG. 8 shows an exemplary treemap along with various techniques for assigning a size to a graphical unit of the treemap;

FIG. 9 shows an exemplary treemap along with various techniques for assigning a visual indicator (e.g., color, shading, border, etc.) to a graphical unit of the treemap;

FIG. 10 shows an exemplary treemap along with various techniques for assigning a group indicator to a graphical unit of the treemap;

FIG. 11 shows an exemplary method for linking a word plot to a treemap;

FIG. 12 shows an exemplary graphic that presents information for patents, trademarks and copyrights associated with a company;

FIG. 13 shows an exemplary graphic that presents information for a patent portfolio associated with a company;

FIG. 14 shows an exemplary graphic that presents information related to a single patent associated with a company;

FIG. 15 shows an exemplary method for translating a word cloud from one language into another language;

FIG. 16 shows an exemplary graphic of patent and other information for a company;

FIG. 17 shows a series of plots of lexicon versus date and patent count;

FIG. 18 shows an exemplary method for text analysis;

FIG. 19 shows a plot and a table of lexicon related information;

FIG. 20 shows exemplary conclusions based on a lexicon analysis;

FIG. 21 shows an exemplary method for determining an age of a claim with respect to a lexicon;

FIG. 22 shows an exemplary “claim DNA” plot for patents;

FIG. 23 shows an exemplary scheme or architecture for acquiring patent information, filtering and transforming patent information and a platform for viewing and navigating information;

FIG. 24 shows an exemplary web page for displaying patent and other information;

FIG. 25 shows an exemplary system for displaying information with respect to a time, a time frame or events in time;

FIG. 26 shows an exemplary user interface for searching and displaying patent information;

FIG. 27 shows various levels of analysis of information from a global map to a treemap to a document representing an element of the treemap;

FIG. 28 shows an exemplary technique to view patent information that allows for zooming and panning;

FIG. 29 shows an exemplary technique to view patent information that allows for zooming and panning where the size of an element (e.g., document) may correspond to a metric associated with a patent; and

FIG. 30 shows an exemplary user interface that includes a time line and rows or columns.

### DETAILED DESCRIPTION

Across the globe, various mechanisms exist for recognizing or granting rights for intangibles such as inventions, creative expressions, symbols of goodwill, etc. Inventions are typically protected using patents, creative expressions are typically protected using copyrights, and symbols of goodwill are typically protected using trademarks (e.g., including trade dress and the like).

Various exemplary methods, systems, devices, described herein relate to intellectual property and information germane to intellectual property, especially for purposes of assessment or valuation of intellectual property.

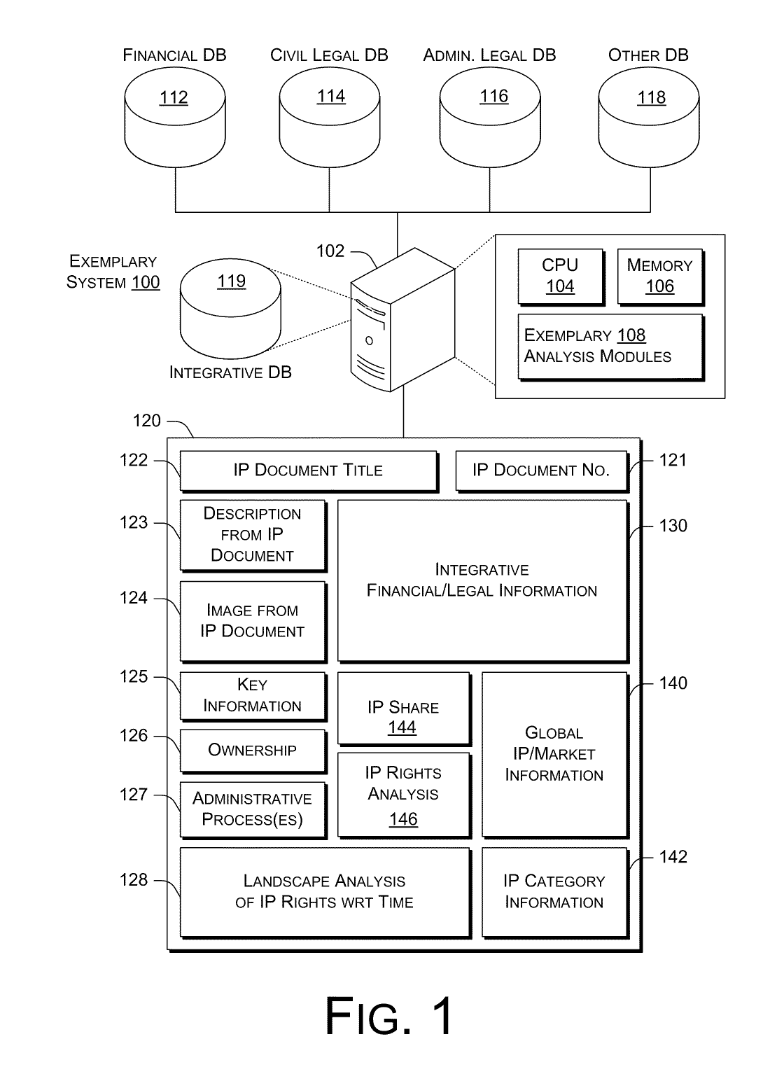

FIG. 1 shows an exemplary system 100 for acquiring and presenting information for an intellectual property document (e.g., intellectual property identification number as assigned by a government agency). The system 100 includes a computing device 102 having a CPU 104, memory 106 and one or more analysis modules 108 for analyzing information. The computing device 102 is representative of a server computing system which may be configured in any number of ways including, for example, as one or more servers (perhaps arranged in a cluster or as a server farm), a mainframe computer, or other server architectures. The computing device 102 may, in certain implementations, represent a site that is accessible over a network, such as website for information. The memory 106 is representative of a wide range of memory configurations (e.g., volatile and non-volatile memory) and capacities (e.g., disk drives, disk arrays, RAID systems, etc.).

The computing device 102 is configured to access information, such as information in the databases 112, 114, 116, 118, over one or more networks. In the example of FIG. 1, information is available from a financial database 112, a civil legal database 114, an administrative legal database 116 and/or one or more other databases 118. The financial database 112 can provide stock information and optionally other financial information such as options, bonds, etc. In general, such information is available in near real-time along with historic information. The civil legal database 114 can provide information as to litigation. One example database is the PACER database that tracks litigation dockets for both civil and criminal actions for various jurisdictions in the United States, although other legal databases may be used. The administrative legal database 116 is representative of a database associated with an administrative agency. For example, the administrative legal DB 116 may be associated with the US Patent & Trademark Office. While the term “legal” appears in describing the administrative database, an administrative agency may have a database with non-legal information or quasi-legal information as well, which is contemplated herein. Many administrative agencies make determinations as to rights such as patent rights. Other administrative agencies include FDA, FERC, ITC, SEC, and the like. Other databases 118 may include databases of marketing data, country data (e.g., CIA database), etc.

The information collected in the databases may be of domestic or international scope. For instance, the financial DB 112 may represent databases that hold stock and financial information for US companies, or for non-US companies. Further, the administrative legal DB 116 may represent other sources of information, such as European patent information available from the European Patent Office, or Japanese patent information available from the Japanese Patent Office. Essentially, the computing device 102 may draw from any number of US or world based sources of financial, legal, and IP related information.

The computing device 102 acquires information from the one or more databases 112-118, aggregates the information, and assesses that information via the analysis modules 108. Once processed, the computing device 102 stores the aggregated and analyzed information in an integrative database 119, which allows accessibility to portions or all of the aggregated information.

The computing device 102 is further configured to present the information graphically as indicated by the graphic 120. The graphic 120 may be a printed page or displayed using a display device (e.g., associated with a computer, a terminal, etc.). The graphic 120 consists of a collection of informational items arranged on a page to convey visually certain aspects of the underlying IP asset, such basic information, key statistics, scope of IP rights, and financial information of the asset owner and how the IP related events may impact financial or operational aspects of the asset owner. The graphic 120 may consist of any number of informational items. In certain implementations, the number and arrangement of the items may be configurable by users. For instance, a service hosted on the computing device 102 may allow a user to select from a menu of possible items and arrange those items on the graphic 120. Examples of possible graphics are shown and discussed below. However, these are merely representative, as other graphics may be used to convey the information.

In the example of FIG. 1, the graphic 120 is for an intellectual property document such as a patent or a patent application. In general, such documents have a serial number and/or other identifying number 121. The graphic 120 includes information germane to the document identified by number 121. While a number is stated, the identifier can be letters, numbers, symbols, a combination, and so forth.

In the example of FIG. 1, the graphic 120 includes a title 122, a description from the document 123, an image from the document 124, key information from the document 125, ownership information 126, information about administrative proceedings 127, landscape analysis of intellectual property rights or applied for rights with respect to time 128, integrative financial and legal information 130, global IP and/or market information 140, IP classification and/or category information 142, IP share for an owner 144, and IP rights analysis 146. The graphic 120 is provided as an example; other graphics may have less or more information.

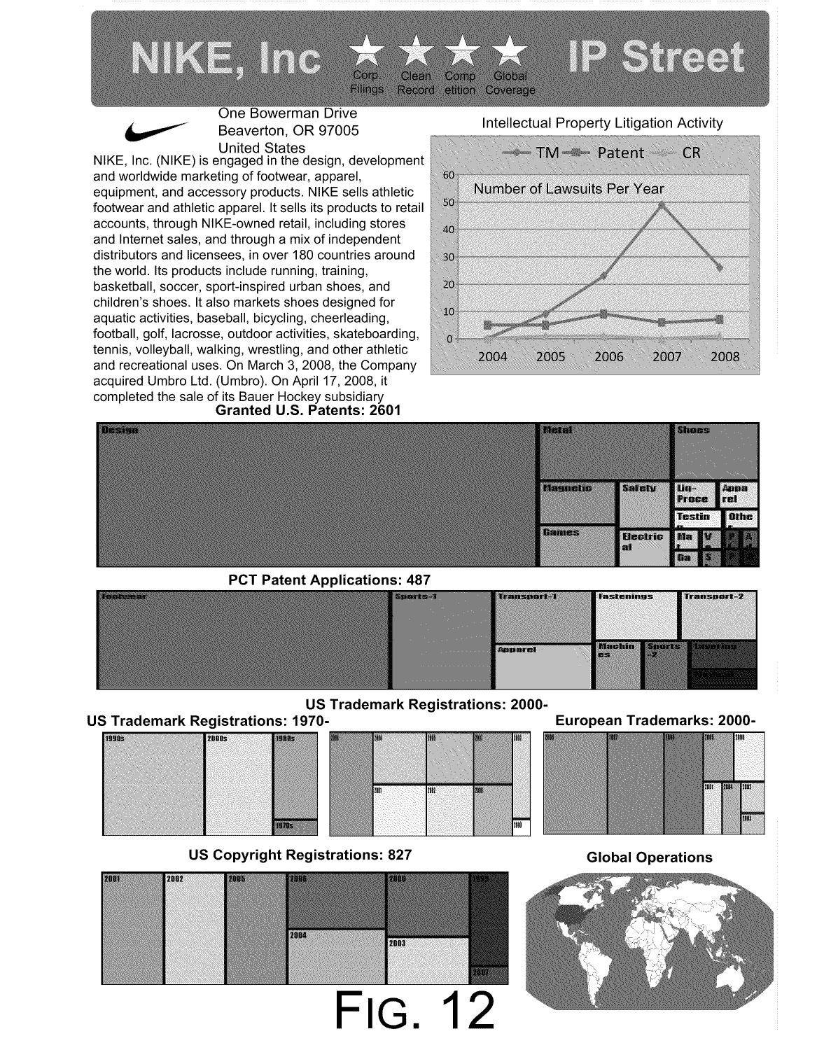

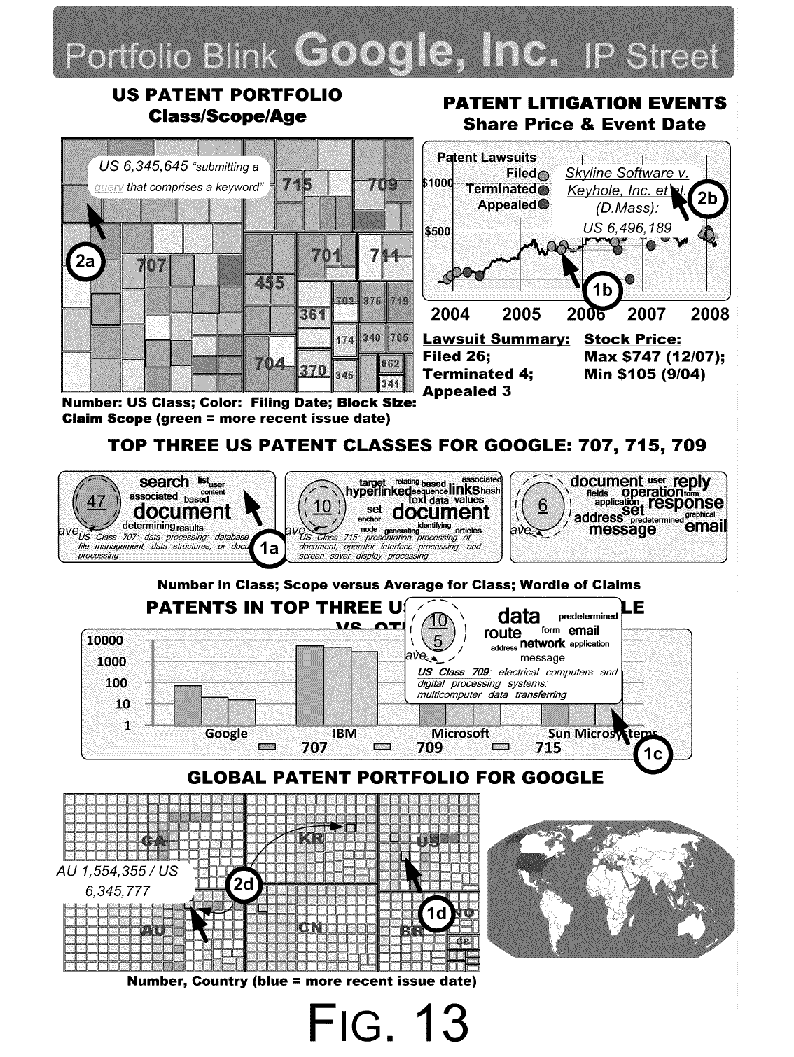

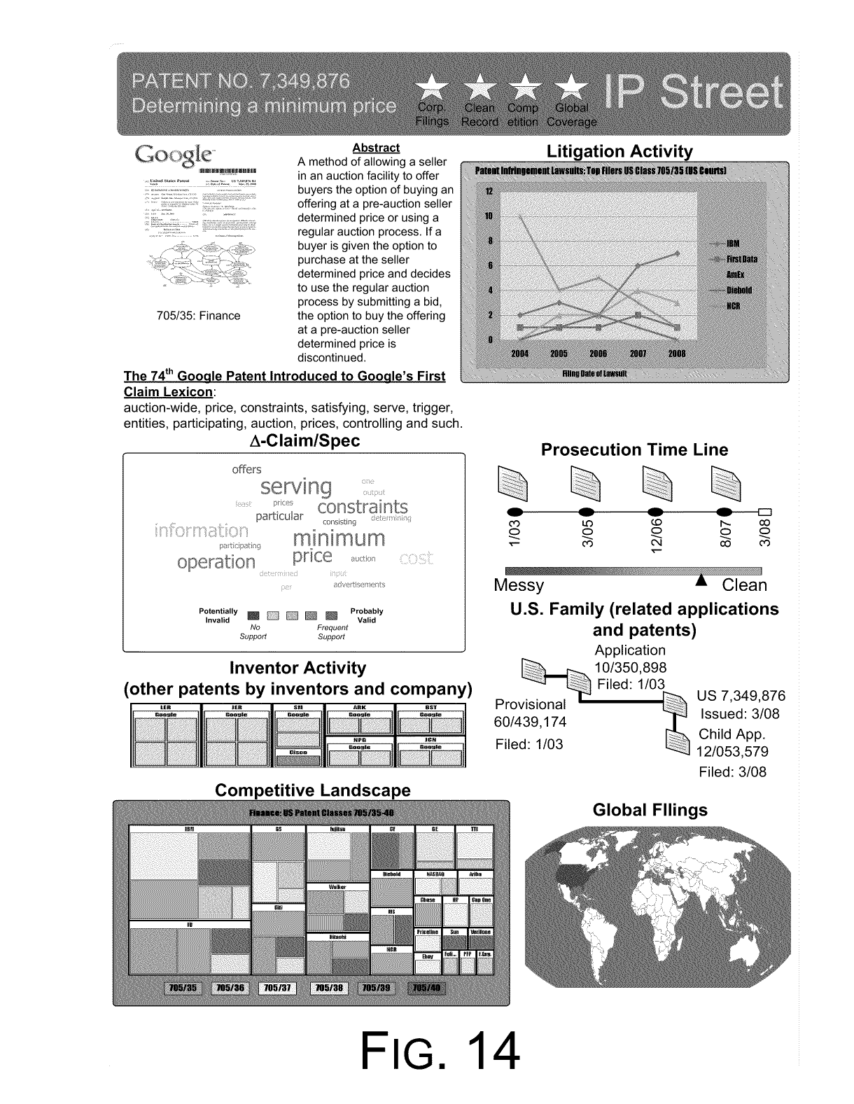

FIGS. 12, 13 and 14 show example documents that may be communicated or presented by a system such as the system 100 of FIG. 1. The graphics 1200, 1300 and 1400 of FIGS. 12, 13 and 14 have some corresponding features to the example graphic 120 of FIG. 1. While there are many ways to depict certain informational items, FIGS. 12, 13 and 14 provide particular non-limiting, additional examples of items that convey visually, certain aspects of one or more underlying IP assets. The graphic 1200 of FIG. 12 corresponds to an intellectual property portfolio for a company, the graphic 1300 of FIG. 13 corresponds to a patent portfolio for a company and the graphic 1400 of FIG. 14 corresponds primarily to a single patent associated with a company.

In the example of FIG. 1, the title area 122 of the graphic 120 is reserved for the title of the document as well as other general data about the document. For instance, the title area 122 of a graphic generated for a patent document may include the inventor name(s) or the assignee of the patent. For a trademark document, the title area 122 may include the assignee of the trademark or the class of goods and services.

The description 123 may include a brief summary of the asset covered by the IP document. In the case of a patent, the description 123 may be the abstract or summary portion of the document. Alternatively, it may be one of the claims, or selected text from the detailed description section of the patent document. In the case of a trademark, it may be a description of the goods or services.

The image 124 provides a visual of the asset being protected by the IP. For a patent, the image 124 may include an illustration from the patent document, such as one of the figures. For a trademark document, the image 124 may include an image of the mark.

The key information 125 is provided to allow the system administrators to designate certain data for inclusion on the graphic. For a patent document, such key information may include a filing date of the application, an issue date of when the patent issued, a publication date, any priority dates, inventor name(s), the US Examiner who examined the patent application, the law firm handling prosecution of the patent, the class within which the Patent Office classified the invention, a claim count (e.g., total claims, independent claims, etc.), the art unit examining the application, the allowance rate of the art unit, other related patents or applications, key references cited during prosecution, and so forth. Similar information may be provided for other IP assets, such as trademarks and copyright registrations.

The information used to populate the title 122, description 123, image 124, and key information 125 may be retrieved from one or more databases (DBs). For instance, much of this information may be found at an administrative legal DB 116 maintained by the US Patent and Trademark Office. Alternatively, this information may be retrieved from other commercial sources, such as services promoted by Thomson®, Lexis/Nexis®, and Google®.

The ownership area 126 is provided for a graphic showing the chain of ownership from the time of filing to the present. For an IP document, such as a patent, this area visually depicts assignment data retrieved from the administrative legal DB 116 of the US Patent and Trademark Office.

The administrative process area 127 concerns key data pertaining to how the IP asset was formed. Consider the context of a patent document. When securing a patent, an applicant first files a patent application with the US Patent and Trademark Office, where it is examined. During the examination process, a record is created detailing the Examiner's review of the application and any responsive comments or changes to the patent application made by the applicant. For instance, the Examiner often rejects the initial application on the grounds that the invention as claimed is not novel or is obvious in view of that which is already known in the field of technology. The Examiner cites prior art references and submits arguments as to why the invention as claimed should not be allowed. In response, the applicant commonly submits rebuttal arguments and may on occasions amend the claims to change their scope in an effort to persuade the Examiner that the application should be allowed. This process is called “patent prosecution” and the record created is typically referred to as the “file wrapper history” or simply “file history”. During this process, the scope of the IP asset may change and this scope change often has an impact on the value of the ultimate IP asset.

The computing device 102 retrieves the file history (or other administrative record) from the US Patent and Trademark Office (or other appropriate agency) or from a third party supplier. The analysis modules 108 classify and extract key portions of the file history and store them in the memory 106. For instance, in the context of patents, the analysis modules 108 may identify claims, amendments to the claims, arguments made by the Examiner, rebuttal arguments advanced by the applicant, key references, excerpts from those references, pertinent filings or admissions (e.g., terminal disclaimers, information disclosure statements, etc.), reasons for allowance, and so forth. Various forms of analysis (e.g., statistical, semantic, etc.) may be performed on the extracted portions of the file history stored in the memory 106 to provide key insights into the formation of the IP asset.

The administrative area 127 provides a graphic that visually conveys to the reader how the IP asset progressed during the administrative period (e.g., during patent prosecution) and how that process may have affected the scope of the IP asset. The graphic is intended to convey at a glance whether the IP assets scope changed significantly or not during the administrative process. Further, it is intended to reveal whether the process involved many interactions with the agency or a few, as a proxy for how clean or messy the file history, which often plays a role in whether the asset owner chooses to assert the asset in litigation or offer it for licensing.

The landscape analysis 128 is an area that visually conveys information pertaining to how the IP asset fits within a larger context. The landscape may be directed to technology, or a company's portfolio, or to one or more competitors portfolios, or to a particular geographical region, or to any number of contexts.

The integrative financial/legal information area 130 is provided prominently on the graphic 120, in the upper right hand quadrant. It provides one or more visual cues to correlate certain legal events or transactions with certain financial parameters. In one example, the integrative financial/legal information area 130 includes a stock chart showing the historical stock performance of the company that owns the IP asset over a period of time (e.g., week, month, quarter, year, multiple years, etc.). Overlaid on this chart are indicators showing related legal events, such as litigation events, patent issuance events, settlements, licensing transactions (if known), and so forth. This information is intended to convey whether certain legal events had any impact on the stock performance of the company. It is noted that other financial data and other events may be correlated in this space on the graphic 120 to allow the reader to assess quickly whether there has been a financial impact on the company due to a legal event.

The global IP/market information area 140 is provided to correlate market data with IP-related legal aspects. For instance, in one implementation, the global IP/market information area 140 visually conveys market data about a product being protected, in part, by the corresponding IP asset. As an example, suppose the graphic 120 is for a US Patent covering a communications chip used in cell phones. Here, a world map may be shown with different regions of the world color coded to exhibit different cell market growth rates (or penetration rates, or sales figures, or other market data). Correlated with this view is another view of how well the IP asset maps to those regions. In one example, a second world map is juxtaposed with the first one and shows through different colors those regions in which the IP asset is protected by patents. In other implementations, such as those involving an interactive UI, the two world maps may be consolidated, and the user can hover over the various regions to learn whether the market data and whether IP rights for this asset extend to the selected region.

The IP category information area 142 provides information items pertaining more generally to IP data relevant to an IP document. For instance, the area 142 may provide information about the class within which the IP document is assigned. It may alternatively provide information about the group art unit within which the IP document was examined, or the family tree showing other related IP documents, or IP filing rates in this particular technology worldwide.

The IP share area 144 contains information items derived from analysis of ownership of IP documents within a particular technology area or class of the IP document being assessed. For instance, this area 144 may provide a breakdown of ownership of the IP documents in a particular class at the US Patent and Trademark Office to which the subject IP document belongs.

The IP rights analysis area 146 is an area reserved for results of an analysis of the scope of rights attached to the IP document. In the context of patents, the scope of a patent document is dictated by the scope of the claims. Thus, the analysis is performed on the claims of the IP documents, and a graphical representation of scope is generated for presentation.

The graphic 120 produced by the system 100 may be used in many contexts. Financial professionals may use the graphic 120 and other higher level analyses to investigate the ties between financial aspects of a company and that company's IP portfolio. IP professionals may use the graphic 120 as a portfolio tool to analyze their own portfolios, as well as others (e.g., competitors, acquisition targets, etc.). IP professionals may further use the graphic 120 in transactions, as well as to assess opportunities in geographical regions or technology sectors.

It is further noted that FIGS. 1, 12, 13 and 14 present merely some possible layouts and formats. The graphic 120 may consist of more or less items than shown in these figures. Moreover, other graphical items may be substituted in place of the ones described and discussed above in the exemplary context.

As described herein, information may be presented in a variety of manners. For example, information may be presented via a web browser interface, a printed page, an electronic document, an active electronic document, a portfolio of documents, etc.

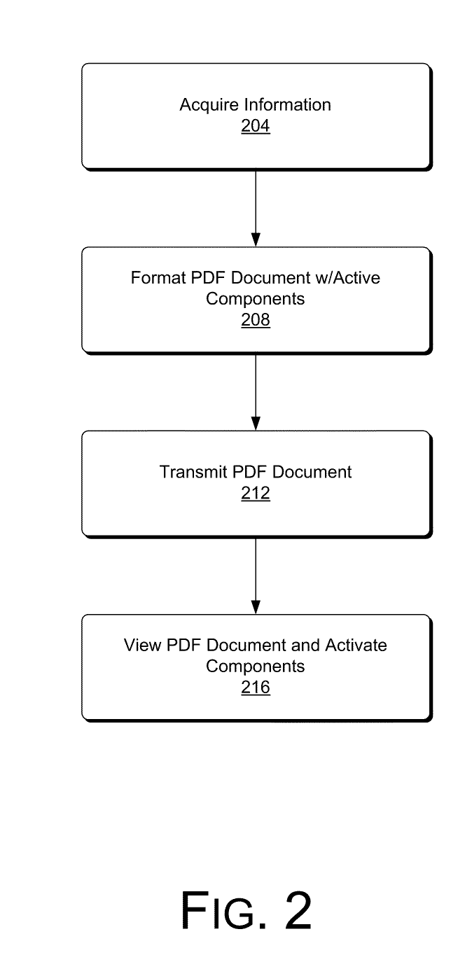

FIG. 2 shows an exemplary method for generating and transmitting an interactive electronic document. The particular example refers to a portable document format (PDF). PDF is a file format developed by Adobe Systems. The PDF format can use formatting information from a variety of desktop publishing applications making it possible to send documents and have them appear on a recipient's monitor (or printer) as they were intended to be viewed. A PDF file can be shared, viewed, and printed by anyone using the free Adobe Reader software, generally in an operating system agnostic manner.

In an acquisition block 204, information is acquired. In a formatting block 208, a document is formatted with interactive (e.g., active) components. In a transmission block 212, a formatted document is transmitted (e.g., via a network) and in a view block 216, the document is viewed using a software application where the active components in the document may be activated by user input (e.g., clicking on a button, mouse over, etc.).

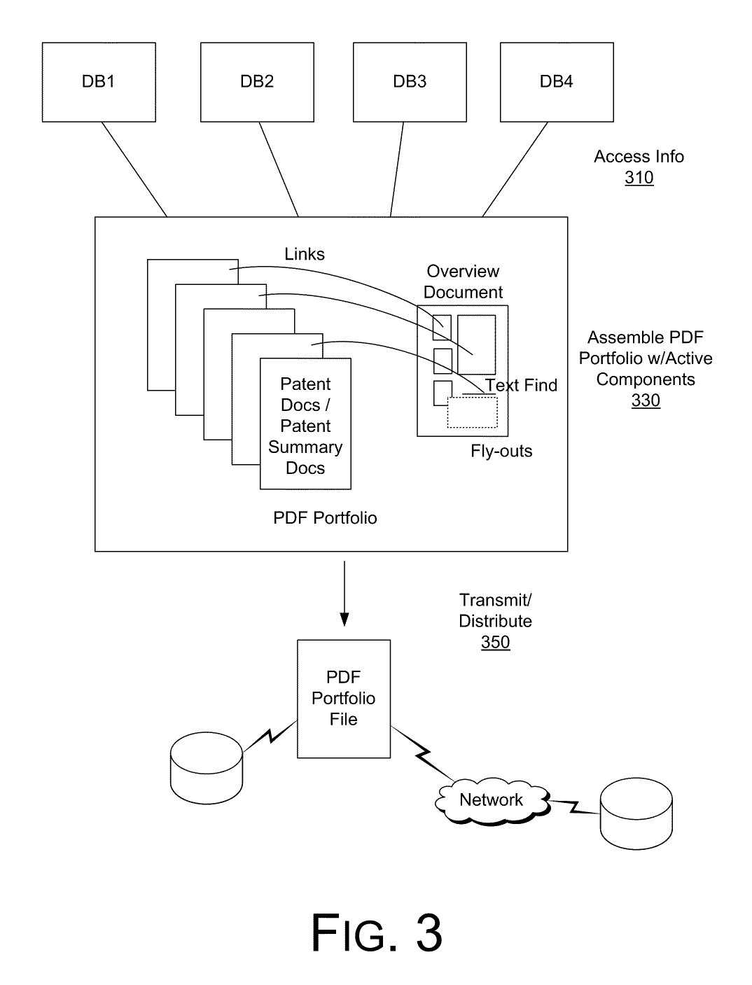

FIG. 3 shows an exemplary method for generating a portfolio file. In the example of FIG. 3, the portfolio file is a PDF portfolio file. A PDF Portfolio contains multiple files assembled into an integrated PDF file unit. The files in a PDF portfolio can be in different formats and created in different applications. For example, a PDF portfolio file can include text documents, email messages, spreadsheets, CAD drawings, and PowerPoint presentations. In the PDF portfolio file, original files retain their individual identities but are assembled into one PDF Portfolio file. Users can open, read, edit, and format each component file independently of the other component files in the PDF portfolio.

Documents in a PDF portfolio can be sorted. For example, a user may sort component files by categories. Active components may facilitate sorting. For example, a button placed in a PDF document may link to instructions to sort documents in a PDF portfolio file.

Text in a PDF portfolio file can be searched. A user or active component may search one or all files in a PDF portfolio file. A search may also search non-PDF files in the PDF portfolio.

A document in a PDF portfolio file may link to one or more other sources. For example, a link may access a document from a data store, which may be local or remote. FLASH video technology skins may be provided for viewing PDF portfolio files and Power Point presentations. Adobe Presenter can activate Power Point files and embed in a PDF file or post on Acrobat Connect Pro.

In the example of FIG. 3, in an access phases, the method accesses information from one or more databases 310. In an assembly phase 330, the method assembles a PDF portfolio file with various active components. In a transmission or distribution phase 350, the method transmits or distributes the PDF portfolio file. The PDF portfolio file may be configured to access one or more local data stores, one or more remote data stores or a combination of local and remote data stores.

An exemplary portfolio file includes text from a plurality of patent documents (e.g., issued patents and/or patent applications). In this example, the portfolio file includes a summary file with active components. A particular active component, when activated by receipt of user input, causes a search of the text from the plurality of patent documents. The results of the search may be presented to a user in any of a variety of manners. For example, a graphic associated with the summary file may be displayed (rendered) to show a user the patent documents that include a search term. The graphic 1300 of FIG. 13 shows a process whereby a user may select a word that causes a change in the graphic to display patent documents that also contain that word (e.g., in a claim, in the specification, etc.). The graphic 1300 of FIG. 13 may be a PDF portfolio file document with one or more active components that allow for operations related to text (predetermined operations or other) in a plurality of patent documents (e.g., patent applications, issued patents, etc.).

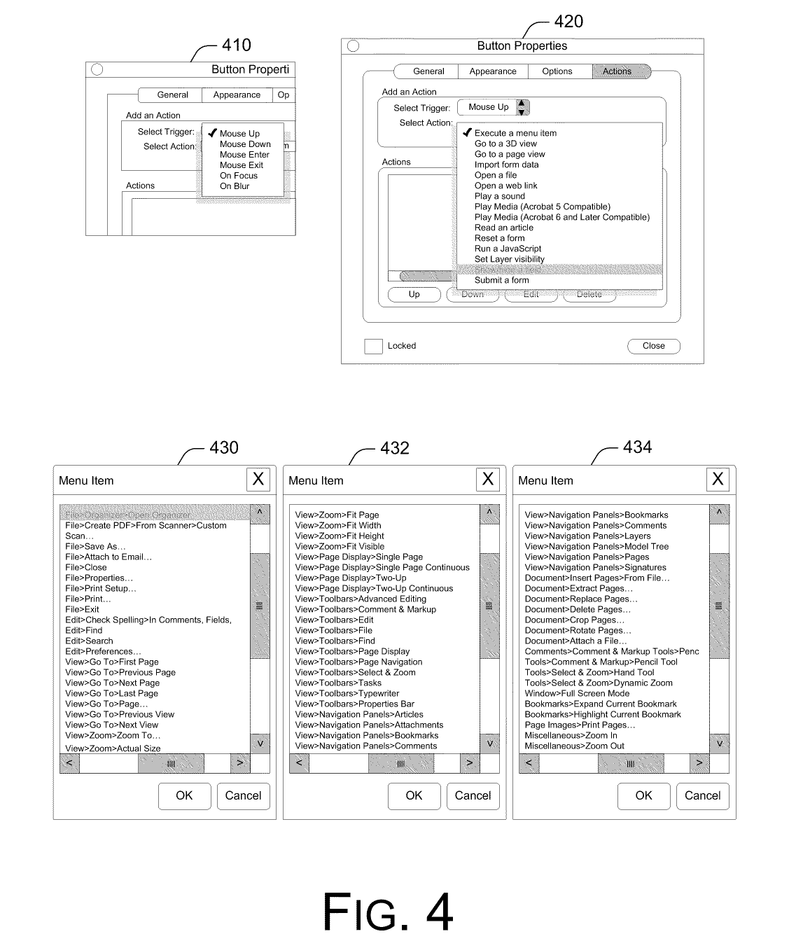

FIG. 4 shows features and processes associated with PDF documents that allow for active components. FIG. 4 shows “button properties” options in a user interface 410 and a user interface 420. In the user interface 410, options exist for selecting a trigger for an action (mouse up, mouse down, mouse enter, mouse exit, on focus, on blur). In the user interface 420, options exist for selecting an action (execute a menu item, go to a 3D view, go to a page view, import form data, open a file, open a web link, play a sound, play media, read an article, reset a form, run a JavaScript, set layer visibility, show/hide a field, submit a form). With respect to menu items, FIG. 4 shows various menu items 430, 432, 434 that can be activated via a button.

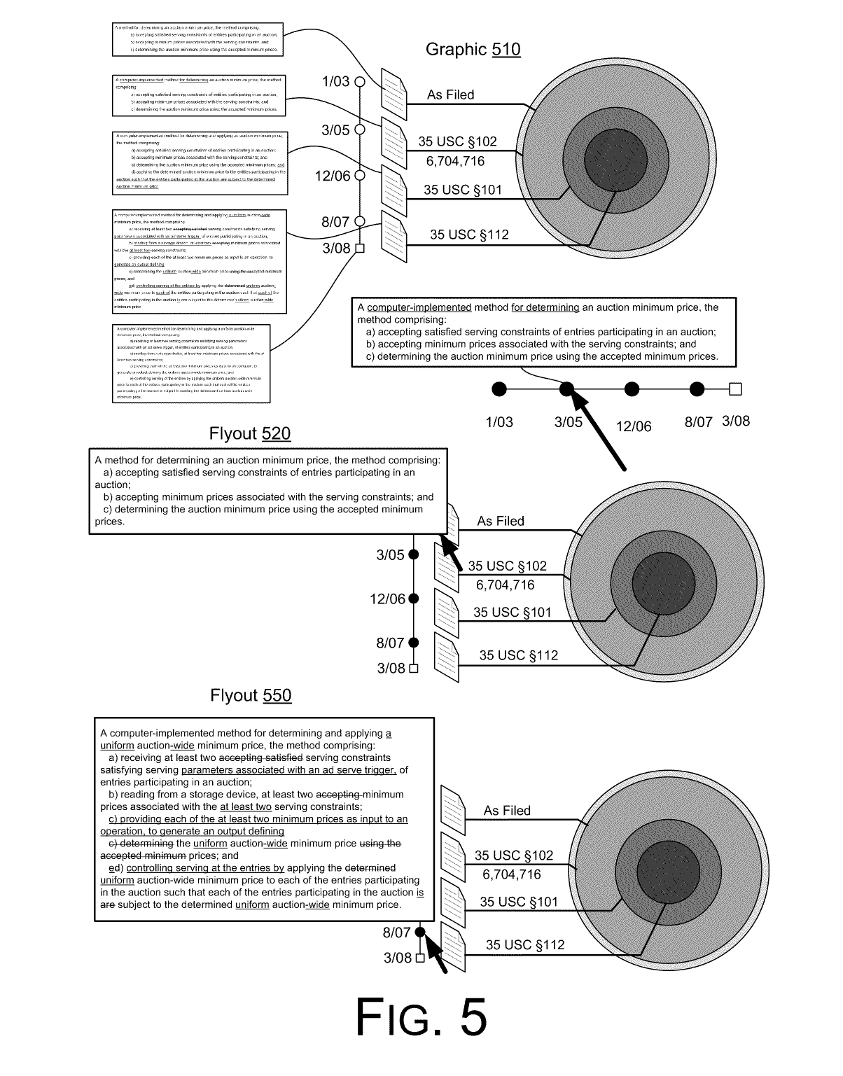

FIG. 5 shows an exemplary technique for presenting information related to patent prosecution and specifically patent claims. A graphic 510 includes a timeline and various information along with a 2-D graphical representation of claim scope with respect to time. A cursor may be positioned on a timeline and cause display of patent claim or other information. In the flyout graphic 520, a user positions a cursor over the “as filed” graphic associated with the timeline. In response, a flyout of the claim language as filed appears (see, e.g., the foregoing discussion of pdf documents). In the flyout graphic 550, a user positions a cursor over the date 8/07 associated with the timeline. In response, a flyout of the claim language as filed appears (see, e.g., the foregoing discussion of pdf documents). In this example, markings are shown as to claim amendments associated with that date in prosecution.

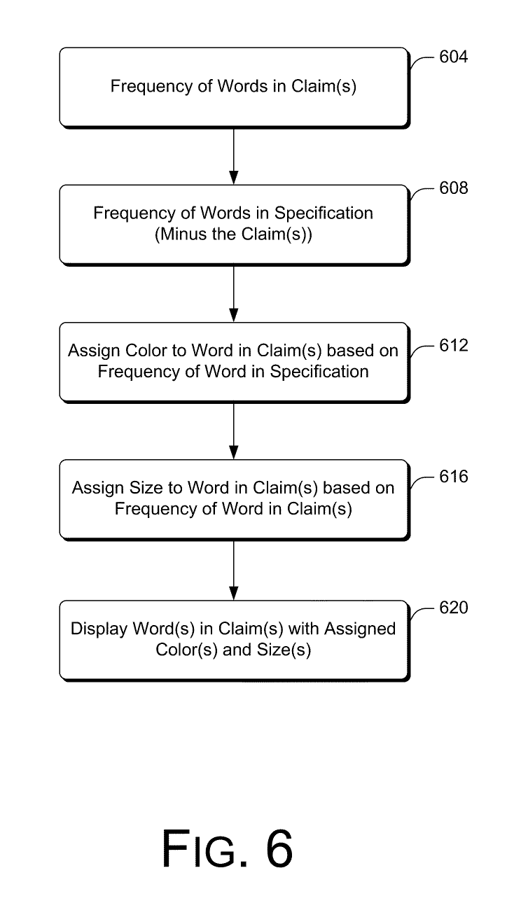

FIG. 6 shows an exemplary method for generating a word cloud with features that correspond to aspects of a patent application or a patent. In a block 604, a frequency count occurs for words in a claim or claims. Such a count may include filtering to remove words or to group certain words (e.g., based on roots, consider stemming techniques). In a block 608, a frequency count occurs for words in the specification corresponding to the claims (e.g., the body of the patent application except for the claims). Again, such a count may include filtering to remove words or to group certain words (e.g., based on roots, consider stemming techniques). In a block 612, an assignment occurs to assign color to words in claims based on frequency of the words in the specification. For example, if a claim term does not appear in the specification, it may be shown in red (e.g., indicating a warning that the word does not appear in the specification, which may present legal or interpretation issues), while a claim term that appears frequently in the specification (e.g., 10 or more times) may be shown in green (e.g., indicating that it finds support in the specification, noting that context between the claim term in the claim and in the various instances in the specification may be unknown without further analysis). In a block 616, an assignment occurs to assign a relative size to the words in the claim(s) based on frequency of the words in the claim(s). A display block 620 displays the word(s) in claim(s) with assigned color(s) and size(s). A user may select criteria as to frequency and/or correspondence. For example, a user may wish to display only those claim words with no correspondence in the specification.

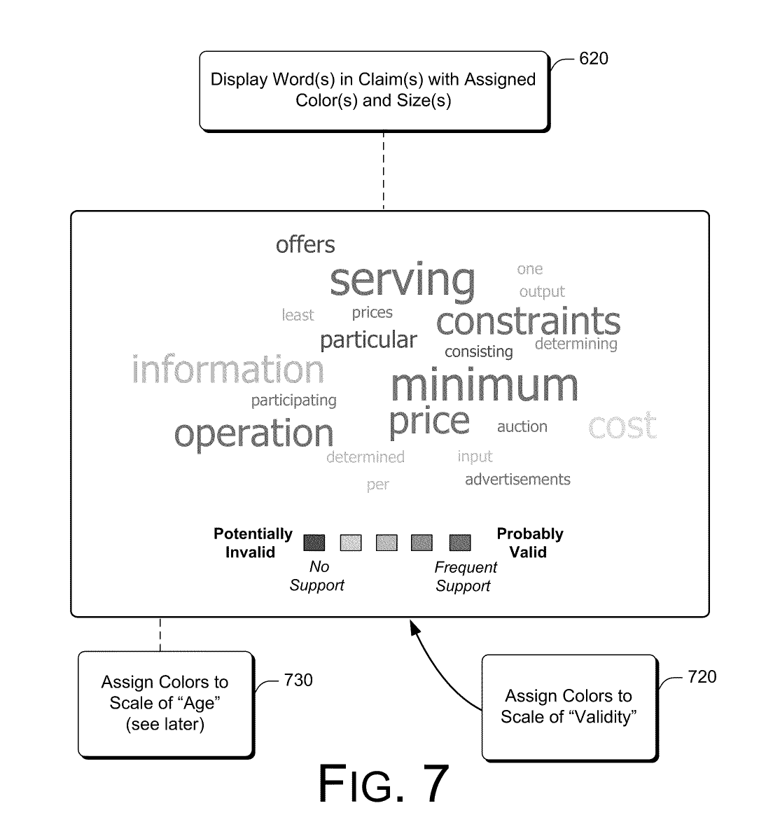

FIG. 7 shows an exemplary word cloud and an exemplary scale that assigns a feature of the word cloud to a quality indicator of a patent application or a patent. FIG. 7 shows the block 620 of FIG. 7 along with a word cloud that includes a scale with legal propositions (e.g., potentially invalid to probably valid) based on support in the specification for the individual words (see block 720). Given the graphic, a user may quickly ascertain a quality metric of the claims of the patent or patent application. Another option 730 assigns colors to scale of “age”, which is described later with respect to age of a word in a lexicon (e.g., a lexicon of an assignee, a class, etc.). A new or young word in a lexicon may have some significance (e.g., indicate introduction of new technology).

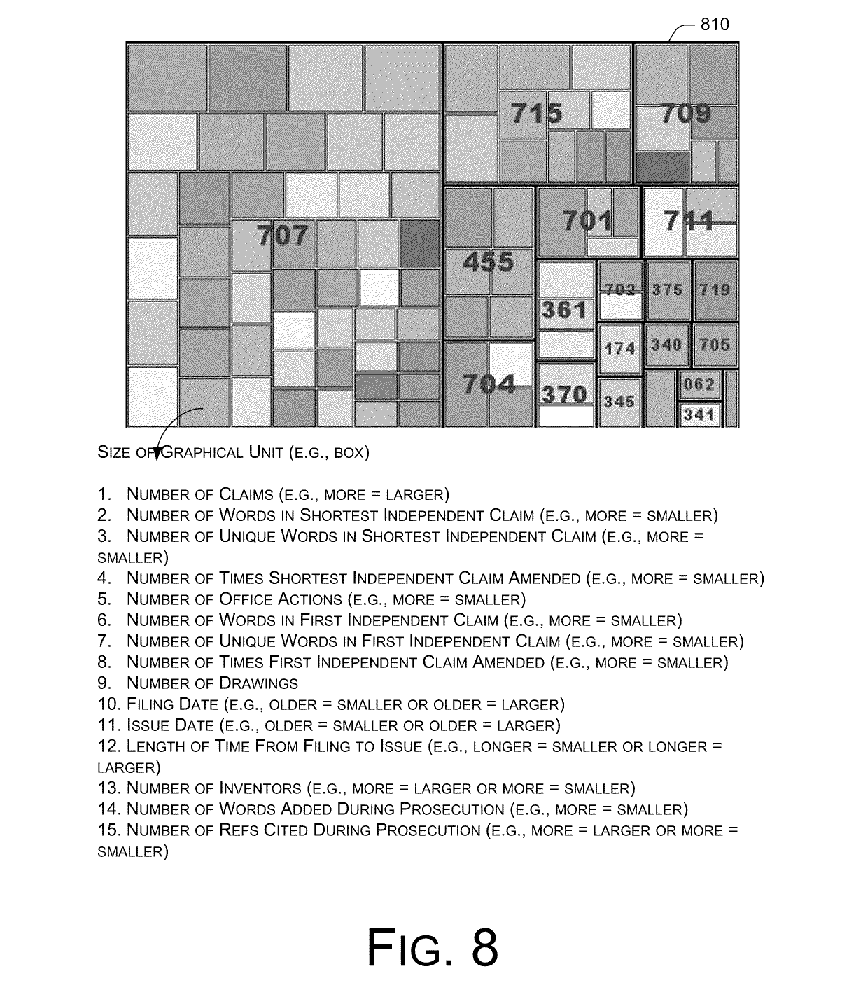

FIG. 8 shows an exemplary treemap 810 along with various techniques for assigning a size to a graphical unit of the treemap. The size of each block in the treemap 810 corresponds to a claim scope metric. Specifically, in the example of FIG. 8, the claim scope metric is the inverse of unique words in a claim; alternatively, inverse of total words may provide a similar metric with some correlation to inverse of unique words. Various examples are listed in FIG. 8 as items 1 through 15. In the treemap 810, color pertains to filing or issue date of the patent or patent application. Thus, a user may ascertain some information about potential claim scope and time (e.g., newness, when a patent will expire, trends in a portfolio with respect to claim scope and time). Additionally, the treemap 810 is segregated with respect to US patent class.

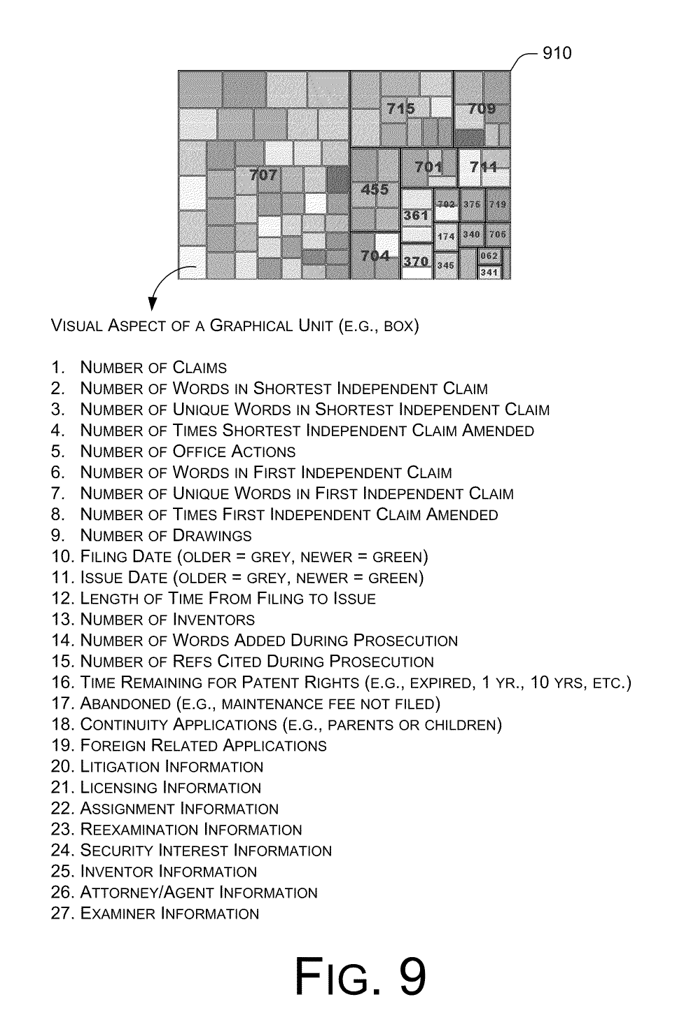

FIG. 9 shows an exemplary treemap 910 along with various techniques for assigning a visual indicator (e.g., color, shading, border, etc.) to a graphical unit of the treemap.

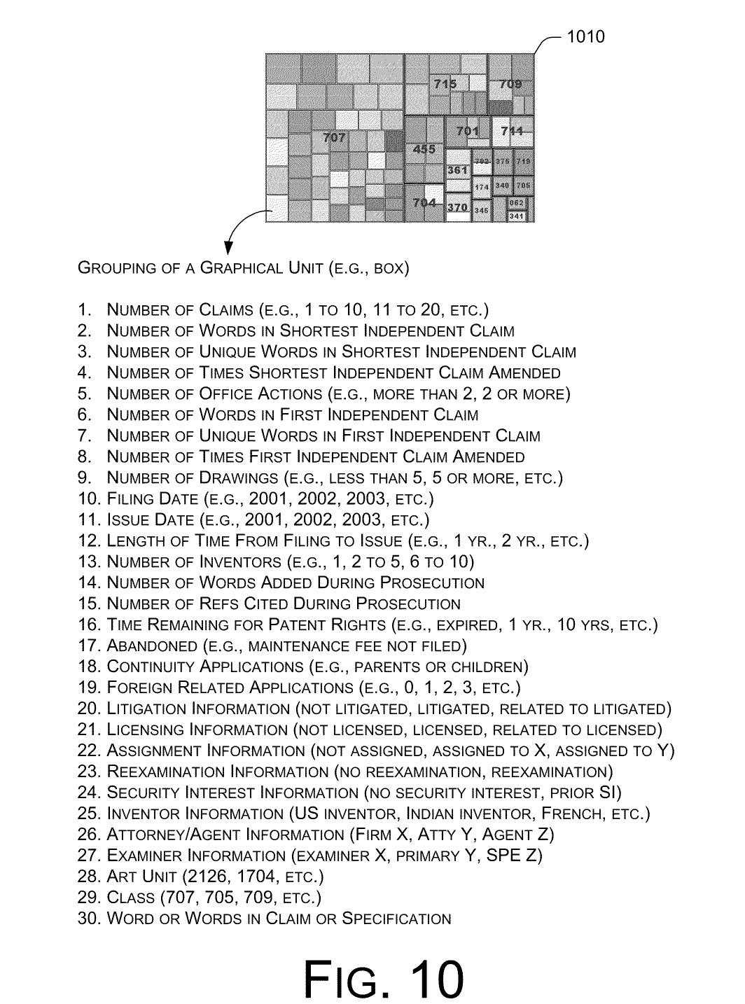

FIG. 10 shows an exemplary treemap 1010 along with various techniques for assigning a group indicator to a graphical unit of the treemap.

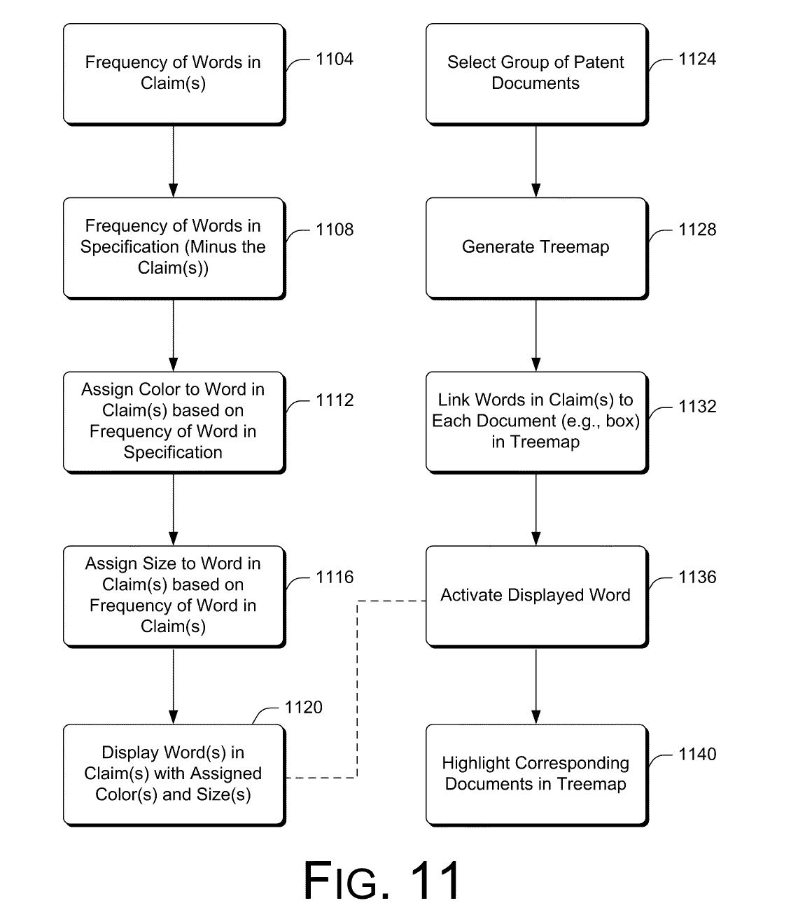

FIG. 11 shows an exemplary method for linking a word plot to a treemap. In blocks 1104-1120, word cloud information is generated. In block 1124, a group of patent documents is selected (e.g., in response to a search query, a criterion or criteria selection, etc.). In a block 1128, a treemap is generated (e.g., using a treemap generation algorithm). In a block 1132, linking occurs between words in claims to each document (e.g., a box) in the treemap. In a block 1136, a user can activate a displayed word in the word cloud display and then in a block 1140 the corresponding documents with a word match are highlighted in the treemap. For example, if the word “determining” appears in the word cloud, a user may hover over the word and in response a data table with the words of the treemap documents is searched for the term “determining”. The treemap documents with the term are then highlighted to allow the user to readily see which treemap documents contain the word in the word cloud.

FIG. 12 shows an exemplary graphic that presents information for patents, trademarks and copyrights associated with a company.

FIG. 13 shows an exemplary graphic that presents information for a patent portfolio associated with a company. In this example, consider 1a-d and 2a-d where pairs 1a/2a, 1b/2b, 1c/2c and 1d/2d demonstrate some actions and/or responses. In action 1a, a user hovers over or otherwise selects a word in a word cloud. In response, per 2a, blocks in a treemap are highlighted as representing documents that include that word. In an action 1b, a user hovers over or otherwise selects a litigation event in the chart. In response, per 2b, a docket caption appears along with the patent involved in the litigation. In action 1c, a user hovers over or otherwise selects a column on a chart. In response, per 2c, a word cloud appears for the documents represented by the column on the chart. In action 1d, a user hovers over or otherwise selects a document in a treemap for documents in multiple countries. In response, per 2d, treemap blocks are highlighted for associated documents (e.g., patents or patent applications in the family of the selected document). A criteria box may appear such that a user may select one or more criteria. For example, a user may select “inventor” where upon selection of one document, other documents listing the same inventor, inventors or at least one inventor in common may be highlighted across the globe and within the same country/region.

FIG. 14 shows an exemplary graphic that presents information related to a single patent associated with a company. In this graphic, an inventor activity treemap appears that indicates how many other patents or patent applications for which each inventor is associated. Further, color coding indicates the assignee. In this example, one of the inventors was named as an inventor for a patent with a different assignee. A litigation activity graphic shows litigation activity for top filers/assignees in the same class or technology as the particular patent. Such a graphic can serve as some evidence of value. For example, if there is a significant patent litigation, then patents of these companies may likewise be significant in some manner.

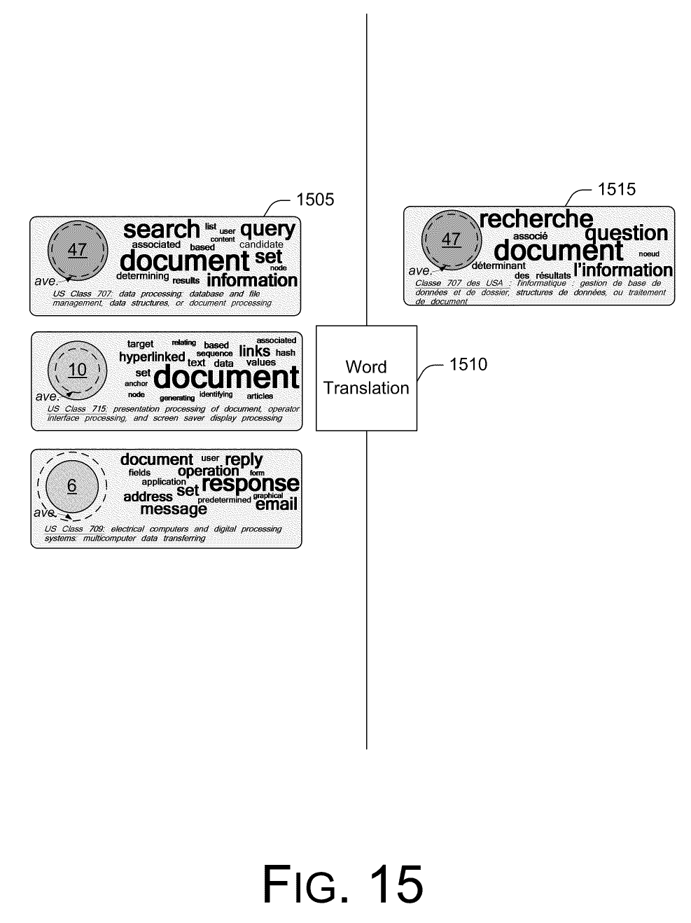

FIG. 15 shows an exemplary method for translating a word cloud from one language into another language. In this example, a word cloud 1505 is provided in English. A word translation block 1510 that relies on machine translation translates words from the word cloud 1505 into French 1515. Such a translation may operate quickly and in near real-time to translate words into any of a variety of languages. For example, a web interface may display a word cloud along with a selection of languages. Upon selection of a language (e.g., check box), the word cloud may be immediately translated and presented in the selected language.

Another variation of the word weighting as in word clouds selects a supergroup of patents that have no particular technical commonality. For example, all Company X patents. Next, the method finds the 100 most “unusual” words in each individual patent, and creates a word cloud based on frequency of occurrence within each individual patent. In this method, only the most unusual words would appear in a word cloud and they would be bigger if they occurred more frequently in that patent. A user may review the word clouds to readily see which patents include unusual words and how often those unusual words occur.

In an example, grouping of Company X patents may occur based on the set of 100 most unusual words in each patent. One can then compare the word set for each patent and look for significant overlaps. If two patents' unusual word sets are 99% identical, then a graphic may indicate that these two patents are likely related. Such a map of relationships may be presented in a 2D or 3D map, allowing navigation between related patents or groups.

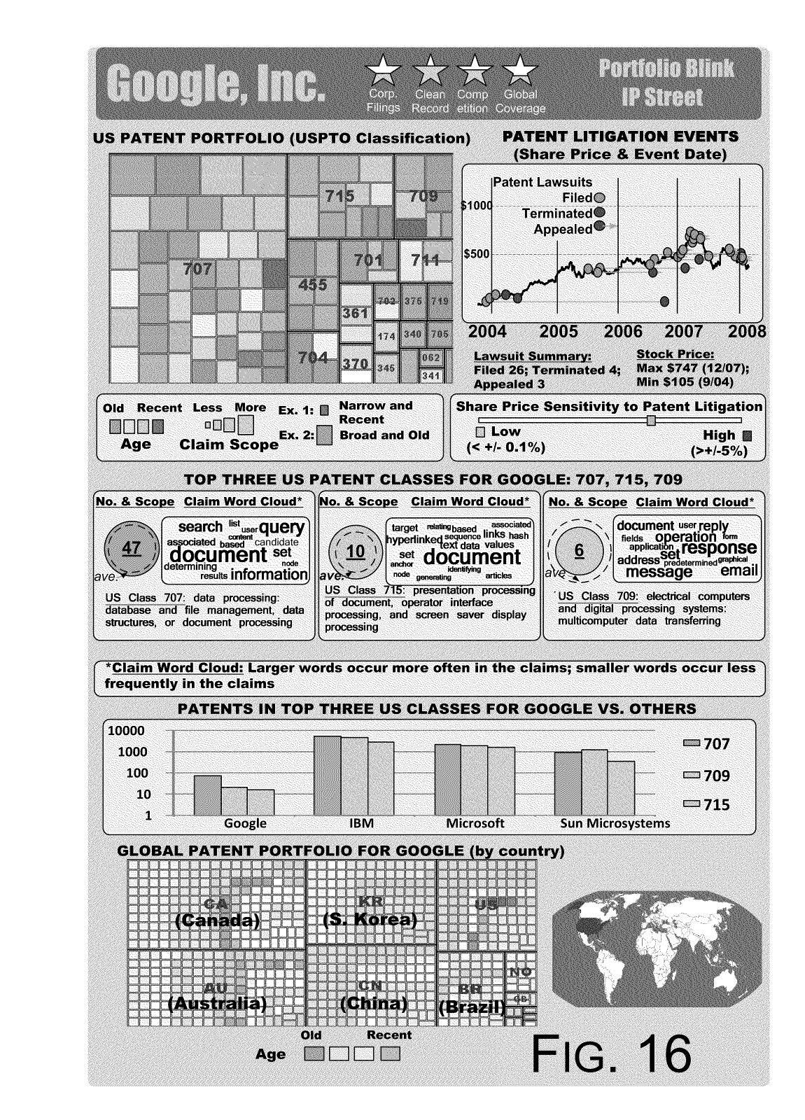

FIG. 16 is a portfolio graphic for a company. This graphic includes a share price sensitivity to patent litigation metric. This metric may be based on an analysis of historical patent litigation events. For example, if a company has an adverse judgment where a patent is held invalid and the stock price moves 5% in response to this event, then the company may be assigned a “high” share price sensitivity to patent litigation. Such a situation may occur, for example, with respect to a small company that relies on licensing revenue of one or a few patents. Where one of these patents is held invalid, a revenue stream is often lost and, in turn, share price decreases reflecting the loss of revenue.

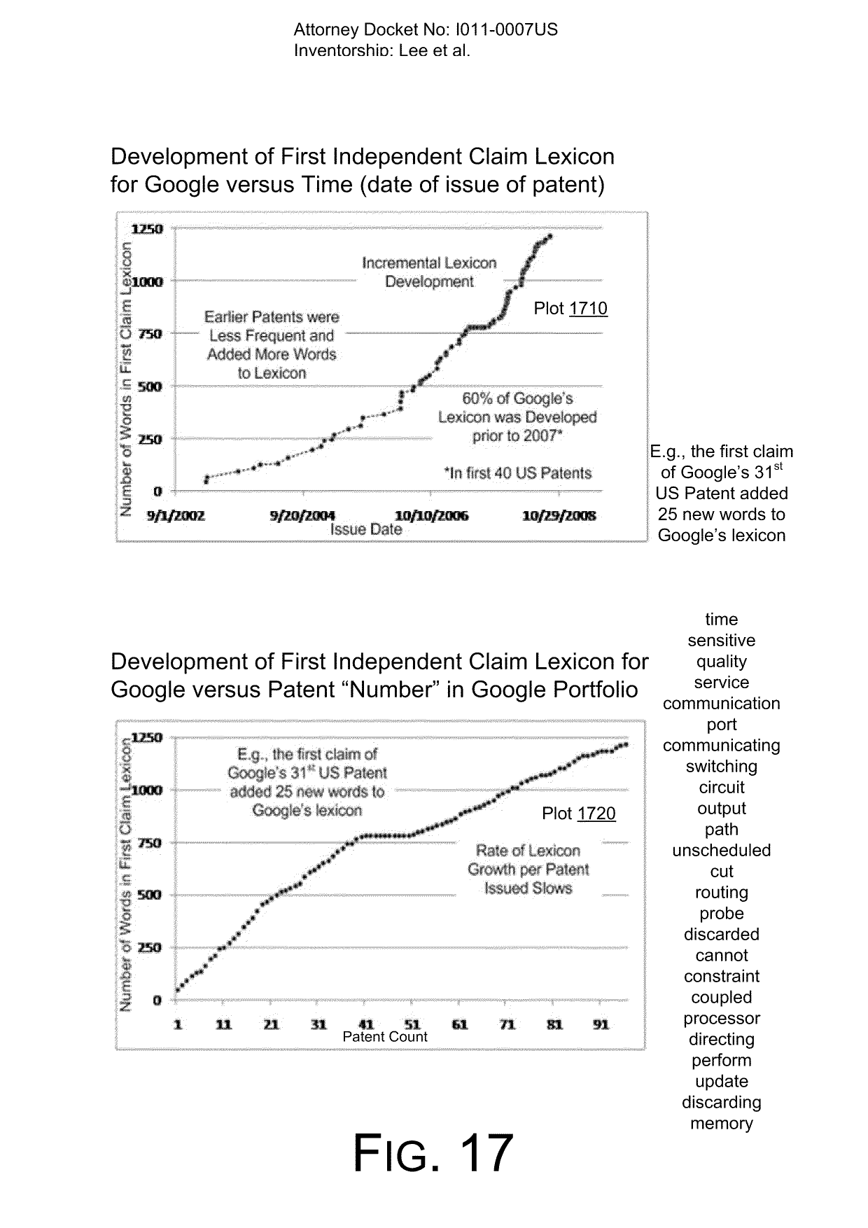

FIG. 17 is a series of plots of metrics for patents of Google. Specifically, the plots show development of a lexicon with respect to time. The top plot 1710 shows number of words in first claim lexicon versus issue date of the corresponding patent. The lower plot 1720 shows number of words in first claim lexicon versus patent count (e.g., from 1 to 100 patents). Hence, in the lower plot, rates of word addition to lexicon appear. Such trends can indicate technology shifts in a company.

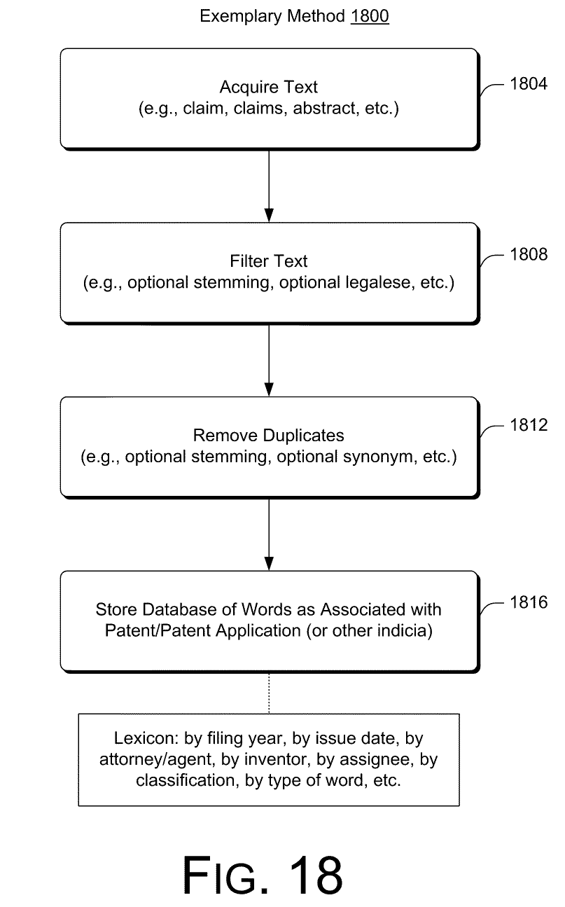

FIG. 18 shows an exemplary method for lexicon analysis. In a block 1804, text is acquired. In a block 1808 filtering occurs. In a block 1812, duplicate handling occurs. In a block 1816, storage occurs of words as associated with patent or patent application or other indicia. Such a method can be used to generate plots such as those shown in FIG. 17.

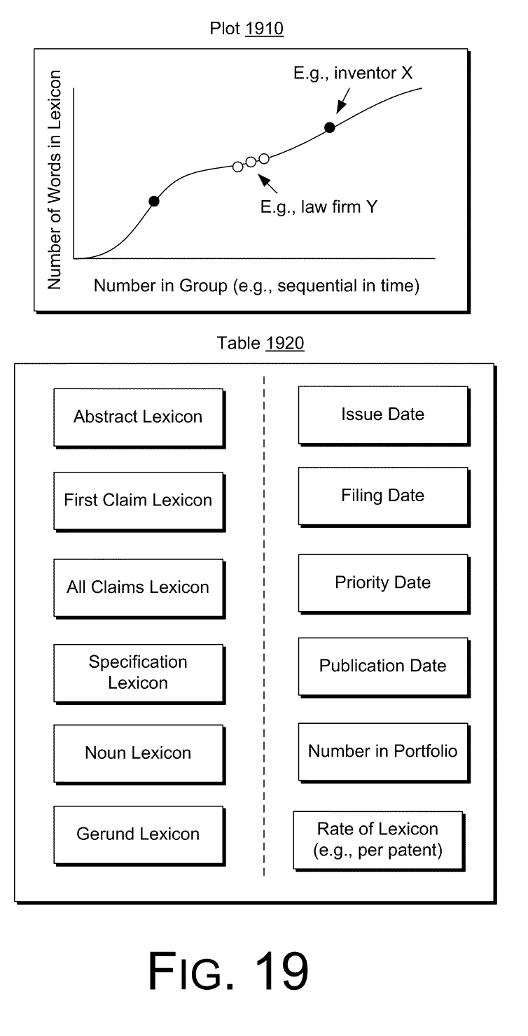

FIG. 19 shows a plot 1910 where additional information may be associated with a lexicon (e.g., inventor X or law firm Y). A table 1920 of some lexicon items and information for lexicon analysis are shown.

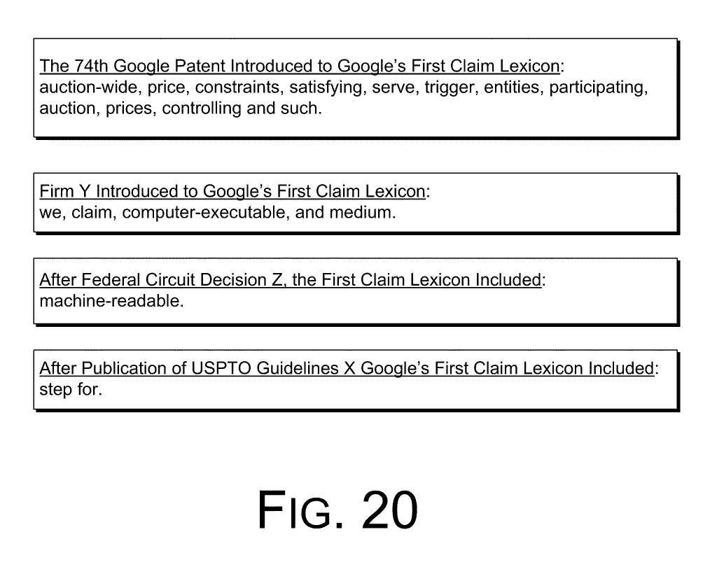

FIG. 20 shows some possible conclusions based on a lexicon analysis as explained with respect to FIGS. 17-19. For example, “The 74th Google Patent Introduced to Google's First Claim Lexicon: auction-wide, price, constraints, satisfying, serve, trigger, entities, participating, auction, prices, controlling and such.” Thus a reader can quickly distinguish “what is new” for Google in the first independent claim of this issued patent. This information can operate synergistically with the Delta Spec/Claim word cloud for the most frequently occurring words in the claims of this patent—color coded by the extent to which each word appears in the specification.

In the lexicon, a claim word “age” may be ascertained. Through lexicon development data, a method can assign an age to a claim based on when the word entered Google's claim lexicon. If a claim contains many “new” words, then it may be assigned a young age—if a claim contains many already used words, then it can be assigned an older age. As mentioned, a method may filter out basic patent words like comprising, method, etc. The age of a claim may indicate whether or not is has “new” material—or old material.

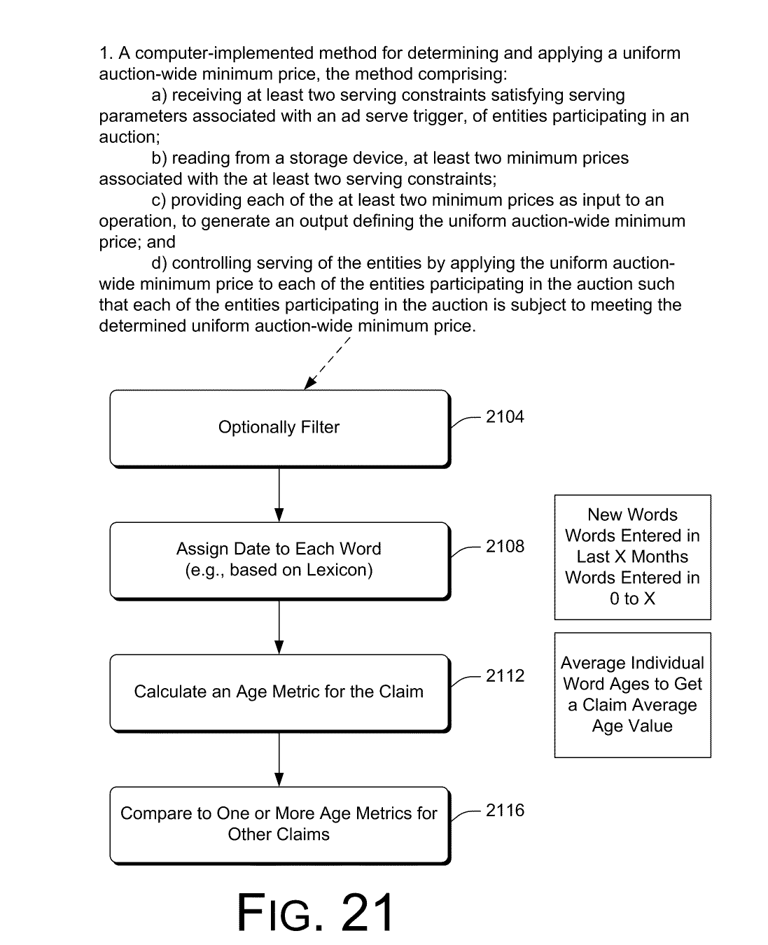

FIG. 21 shows an exemplary method for analysis of a claim. In a block 2104, a filter is optionally applied to the words in a claim. In a block 2108, the method assigns a date to each word (e.g., based on a lexicon as developed). In a block 2112, the method calculates an age metric for the claim based at least in part on the age of various words in the claim (e.g., as may occur in a lexicon developed over time). In a block 2116, a comparison occurs that compares one or more age metrics for a claim to one or more age metrics for another claim or claims.

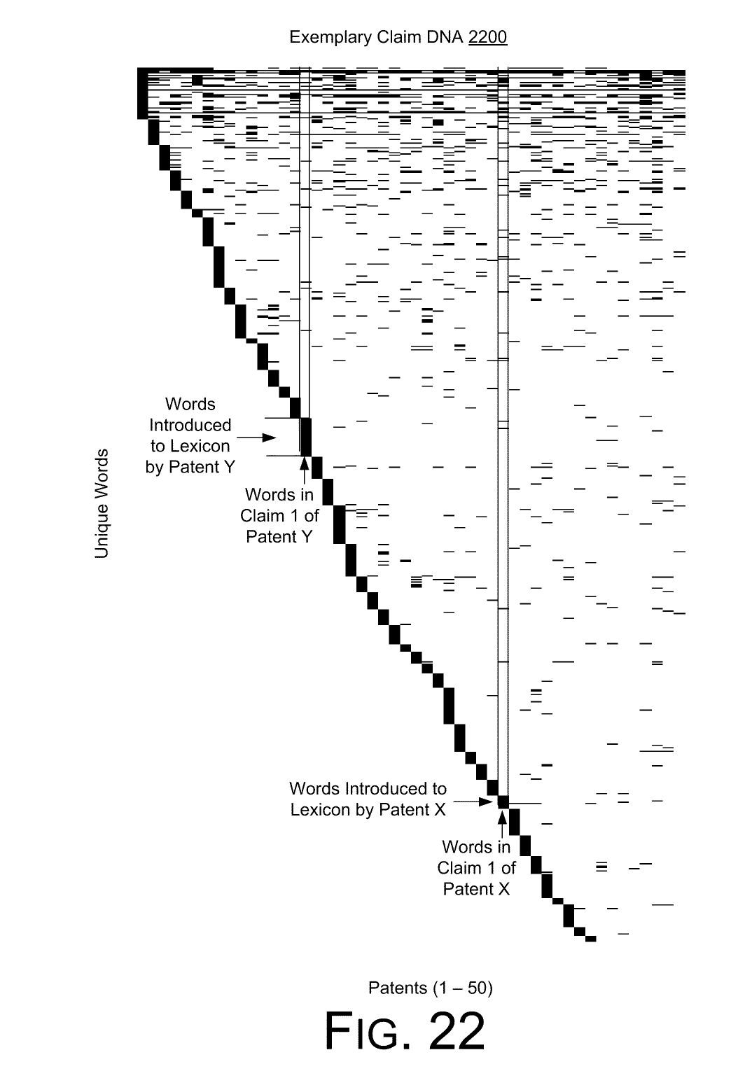

FIG. 22 shows a plot 2200 of so-called “claim DNA”. The plot shows unique words versus patents numbered 1-50 where each filled block corresponds to an instance or instances of a unique word in a patent. Thus, each patent has a “DNA” like strip that corresponds to a lexicon developed over time. If two strips are compared, one may ascertain whether the two patents are likely related.

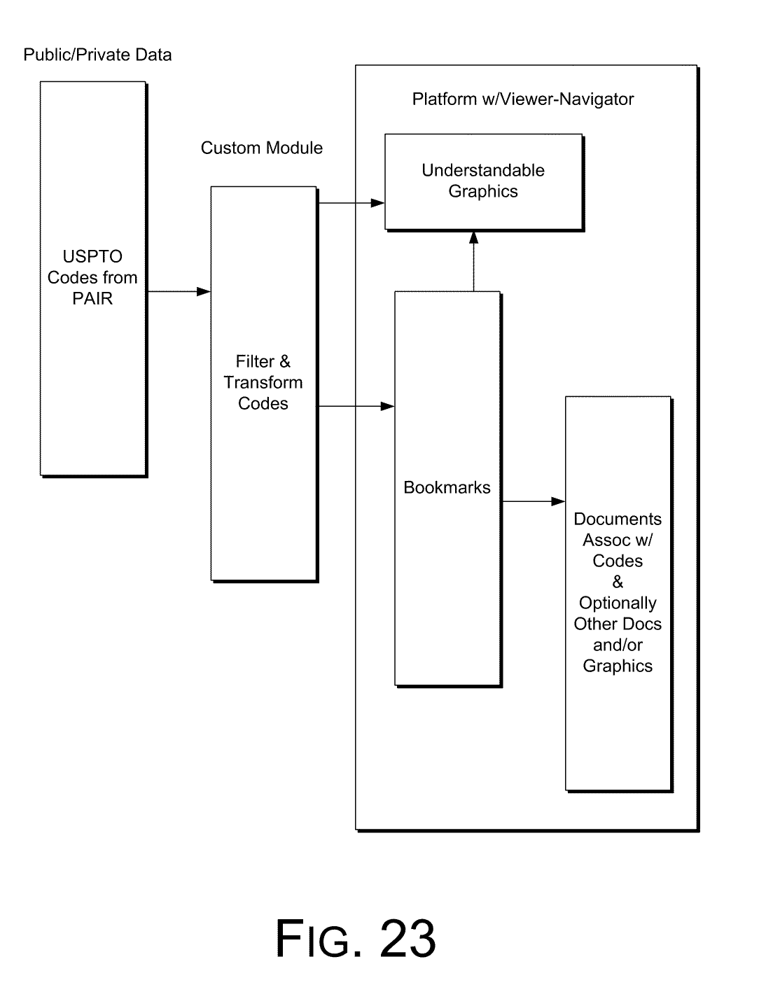

FIG. 23 is a block diagram of an exemplary scheme for acquiring data, filtering and/or transforming the data (e.g., based on codes) and for presenting information using a platform with navigation tools. For example, USPTO data may be acquired from PAIR (public and/or private), a custom module implemented in computer code on a computing device can filter and/or transform the data and a platform can consume the data to provide understandable graphics, bookmarks, documents associated with codes and optionally other documents and/or graphics.

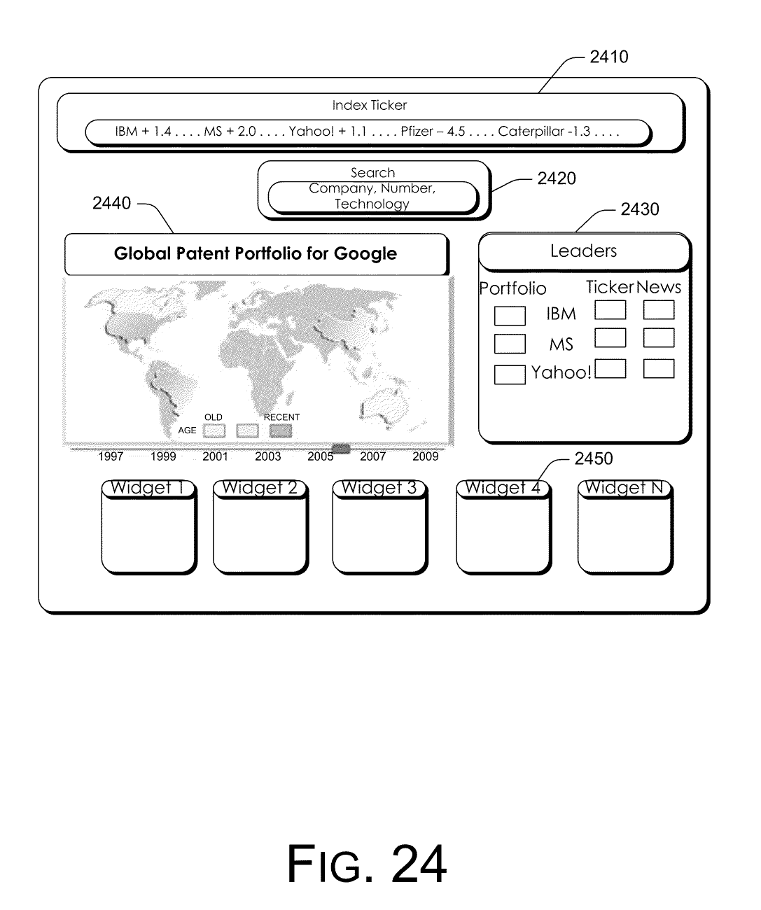

FIG. 24 is a block diagram of an exemplary user interface that may be made of cascading style sheets (CSSs). The user interface includes a ticker 2410 of patent metrics, stock values or other information. The user interface includes a search box 2420 for entry of a query; a leaders in a selected area information area 2430; and a global map 2440. The global map 2440 includes a time control or time slider control that a user may manipulate. In response to user manipulation, an algorithm may access information germane to a query with respect to time and update the global map graphic accordingly. For example, if a user selects a time of 1997 for Google, no patents in the United States will appear according to data available from the US Patent and Trademark Office database. However, if the user moves the slider to 2003, in February 2003, U.S. Pat. No. 6,526,440 issued. As the user moves the slider forward in time more patents will appear according to the underlying data. While the example of FIG. 24 shows a slider that extends to 2009, a timeline may extend to future times (e.g., 2040). In such an example, a user may select a future time to visualize patent expiration, noting that patent expiration may occur for other reasons and prior to the normal expiration of rights date.

FIG. 24 also includes a series of widget blocks 2450. A user may select and activate a widget. Further, the time control can allow for coordinated control of more than one graphic. For example, a user may select a widget that shows claim scope of a single claim in a patent. Where the user manipulates the time control in the global map widget, the claim scope may change as during prosecution over the selected time. Coordinated time control allows a user to readily visualize events with respect to time and ascertain potential or actual trends.

With respect to widgets, a user may use a drag-n-drop interface to arrange widgets and optionally to format a single page document of patent information, IP information, etc. Examples include:

1. Patent statistics—thumbnail of patent
2. Stock Chart with IP events
3. File History and scope change
4. Scope (venn and IP share)
5. Landscape—bubble chart with competitor and text search . . .
6. Global coverage

### 7. Assignment

### 8. Family History

9. Key Amendment History—Extracted amendments for each claim.

### 10. Estoppel Pool

Referring again to the index ticker, such a ticker may display a series of values, for example, where each value corresponds to a patent portfolio value (PPV) for a company's patent portfolio.

An exemplary equation follows:

PPV (patent portfolio value)=w1*Acceleration/Deceleration+w2*Scope+w3*Size+w4*BizEvents+w5*LitEvents+w6*collection of innovative people

In the foregoing equation, w1, . . . w5 are weighting factors, for example, where weights account for accel/decal, scope, size, collection of innovative people (inventors with 5+ patents). Other factors may include R&D spending (increasing/decreasing), additions/departures of innovative people (inventors with 5+ patents), relative scope of patents in key markets (i.e., largest markets and scope rank).

Another metric pertains to scope rank (e.g., where scope reflects claim scope). In a given technology, the index may reflect which company has the best scope rank.

An exemplary intellectual property ticker may be based at least in part on factors such as:
Acceleration (more or less patents issuing over time and/or a component of publishing applications or other scientific/technological articles)
Scope of claims compared to others/peers
Business Events—M&A, licensing, divestitures
Litigation events—win/lose motions or cases

As various factors change on a daily or more frequent basis, a ticker can change on a similar basis and optionally responsive to events (e.g., daily or at times within a day).

At the end of day, an algorithm may calculate closing balances and construct an “IP Chart” that presents closing daily balances (optionally with respect to time along with a timeline control). Such IP balances are optionally overlaid on a stock price for a related equity (or options, etc.) to allow for possible correlation or leading indicators (e.g., using statistical algorithms).

Referring again to the ticker 2410, the ticker can scroll and a chart for a specific company (or selected companies) can optionally show both stock price and an IP value metric. A treemap algorithm can aggregate a portfolio according to value, technology, etc. An exemplary module is configured to allow a user to click into an “IP chart” and return smaller charts based on key products/technologies owned by a selected company.

A method may include disaggregating a patent/patent application file history, storing claim amendments in a first file group a listing of amendments for presentation, and presenting in web document, an electronic document or a physical printout.

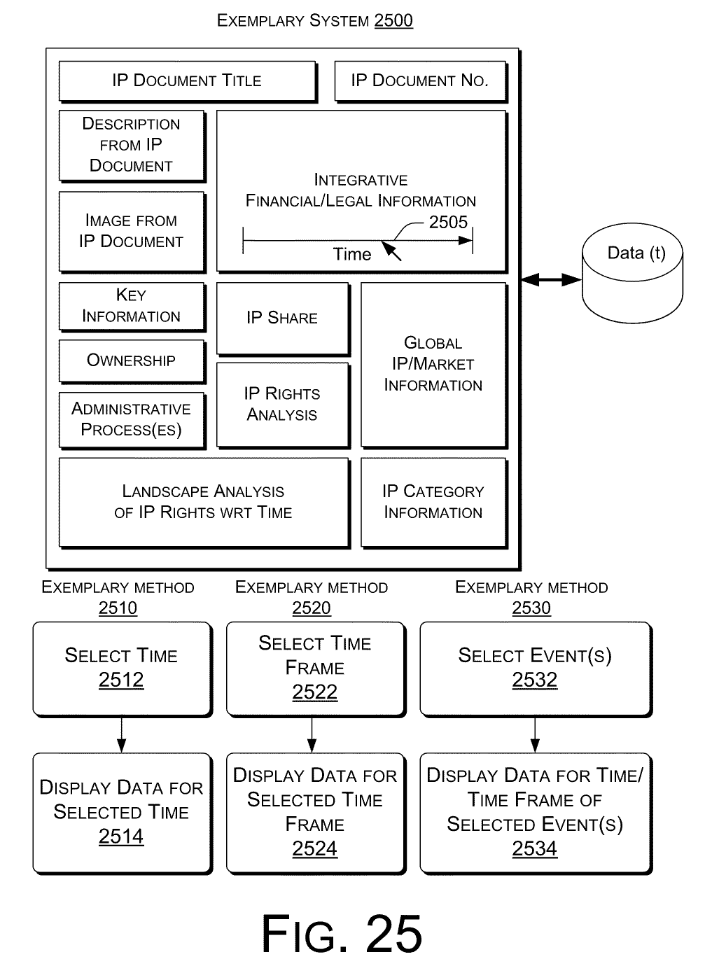

FIG. 25 shows a representation of a figure from one of the related applications, which are incorporated by reference herein. FIG. 25 shows an exemplary system 2500 and various associated exemplary methods 2510, 2520, and 2530 for selecting a time, a time frame, an event or events and graphically displaying information associated with the selected time, the selected time frame, the selected event or the selected events. The graphic includes features of the graphic 120 of FIG. 1 along with a timeline control 2505 that can cause display of certain data. It is noted that the timeline control may alternatively be separate from the graphic document. The time control 2505 allows for methods 2510, 2520 and 2530. As shown in other figures, the time control may appear with respect to a global map. As described herein a time control allows for coordinated control and display of information with respect to time.

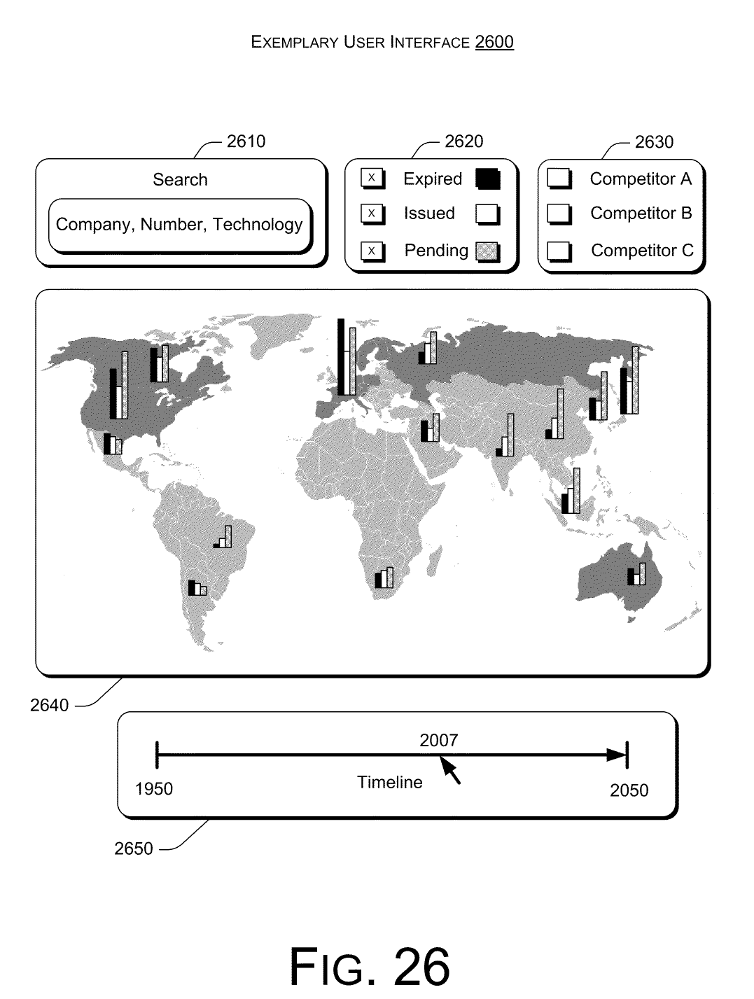

FIG. 26 shows an exemplary user interface 2600. The interface 2600 may be characterized as a “what”, “where” and “when” interface. The interface 2600 includes a search area 2610, a status area 2620, a competitor area 2630, which answer questions as to “what”; a map 2640, which answers questions as to “where”; and a time control 2650, which answers questions as to “when”.

With the user interface 2600, a user can enter a search term. In response, a search occurs of patent-related information. A user may select patent status information in the area 2620. In the area 2630, where a search term is a company, competitors may be displayed that allow a user to also or alternatively view patent-related information for one or more competitors. For example, if Google is entered in area 2610, then search companies such as Yahoo! may be automatically listed in the area 2630.

In the map 2640, the interface 2600 can display patent-related information such as number of expired patents, issued patents and/or pending patents (e.g., patent applications with no corresponding issued patent). In the example of FIG. 26, bars are shown in each country where criteria are met. The user interface 2600 allows a user to select a point in time via the time control 2650. A user may manipulate the slider or elect to automate the slider to move backward or forward in time. Such an approach allows a user to understand better the time dependent nature of patents and patent applications.

Where one or more competitors are selected, the time control 2650 allows a user to visualize aspects of the one or more competitors (e.g., patent applications, issued patents, expired patents) in various countries/regions of the world. Color or other coding may be used to distinguish companies/competitors. The control 2650 extends to the year 2050 to allow a user to visualize expiration of patents, PCT patent applications, etc. Trends may relate to corporate strategies, hiring of key inventors, changes in law firms, mergers and acquisitions, lawsuits, legislation, etc.

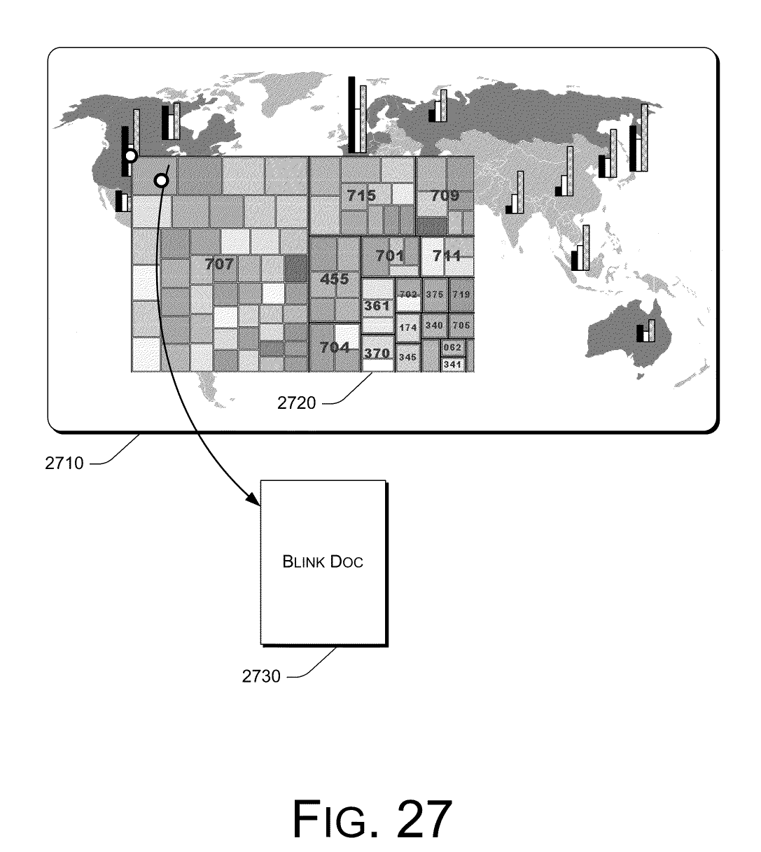

FIG. 27 shows an exemplary method with three levels of analysis: 2710, 2720 and 2730. The first level corresponds to the global map 2710, the second level corresponds to the treemap 2720 and the third level corresponds to the so-called “blink” document 2730. A user may rely on a user interface such as the interface 2600 to drill down to a single patent document in the form of the document 2730 (see, e.g., FIG. 14). An option may also be provided to allow a user to view a single document representative of the selected bar/column (see, e.g., FIG. 16). With respect to aspect ratio, treemaps may have a limit on aspect ratio (e.g., page size such as A4 or 8.5×11). Comparison of size of objects is often easier when the aspect ratio is limited or fixed.

In another example, the treemap can be navigated to zoom into the individual blocks. The Seadragon technology of Microsoft LiveLabs allows for smooth, seamless browsing of vast quantities of visual information. Seadragon Ajax Library provides an application programming interface (API) for adding custom buttons (images or other HTML) onto the viewer. The viewer then controls the visibility and positioning of those buttons, even when going back and forth from full-page mode. Sample source code from http://livelabs.com/seadragon-ajax/library/adding-custom-controls/ follows for BlueMarble.dzi. As described herein, an exemplary treemap is presented as a dzi file and manipulated via Seadragon technology. As described herein, an exemplary map for mapping patent-related information is presented as a dzi file and manipulated via Seadragon technology. As described herein, an exemplary “claim DNA” plot is presented as a dzi file and manipulated via Seadragon technology. In these examples, zooming and panning can allow a user to navigate and see specific aspects of a patent, patent applications, words, text, etc.

SAMPLE CODE:

```
<!DOCTYPE html>
<html>
  <head>
    <script type=“text/javascript”
src=“http://seadragon.com/ajax/0.8/seadragon-min.js”></script>
    <script type=“text/javascript”>
      var viewer = null;
        function init( ) {
        viewer = new Seadragon.Viewer(“container”);
        viewer.addControl(makeControl( ),
Seadragon.ControlAnchor.TOP_RIGHT);
        viewer.openDzi(“BlueMarble.dzi”);
      }
      function makeControl( ) {
        var control = document.createElement(“a”);
        var controlText = document.createTextNode(“Random”);
        control.href = “#”; // so browser shows it as link
        control.className = “control”;
        control.appendChild(controlText);
        Seadragon.Utils.addEvent(control, “click”, onControlClick);
        return control;
      }
      function onControlClick(event) {
        Seadragon.Utils.cancelEvent(event); // so link isn't processed
        if (!viewer.isOpen( )) {
          return;
        }
        var x = Math.random( );
        var y = Math.random( ) / viewer.source.aspectRatio;
        var z = Math.pow(2, Math.random( ) * 10 − 5);
        viewer.viewport.panTo(new Seadragon.Point(x, y));
        viewer.viewport.zoomTo(z);
        viewer.viewport.ensureVisible( );
    }
      Seadragon.Utils.addEvent(window, “load”, init);
    </script>
    <style type=“text/css”>
      #container
      {
        width: 500px;
        height: 400px;
        background-color: black;
        border: 1px solid black;
        color: white; /* for error messages, etc. */
      }
      .overlay
      {
        font-weight: bold;
        margin-top: 4px;
        margin-right: 4px;
      }
    </style>
  </head>
  <body>
    <div id=“container”></div>
  </body>
  </html>
```

The Seadragon technology allows for adding dynamic design elements to an image. The Seadragon Ajax Library allows for creation of overlays that stick to the image as it pans, which can either scale to match the zoom or remain a constant size.

The Seadragon technology allows for event integration or triggering. Sample code follows for “OrionNebula.dzi”, noting that a map, treemap or other file may be substituted and that events may similarly be substituted (e.g., to create and record a history of actions as to what a person did to isolate a patent, etc.):

SAMPLE CODE

```
<!DOCTYPE html>
<html>
  <head>
    <script type=“text/javascript”
src=“http://seadragon.com/ajax/0.8/seadragon-min.js”></script>
    <script type=“text/javascript”>
      var viewer = null;
      var output = null;
      function init( ) {
        viewer = new Seadragon.Viewer(“container”);
        output = document.getElementById(“outputText”);
        viewer.addEventListener(“open”, onOpen);
        viewer.addEventListener(“animationstart”, onAnimationStart);
        viewer.addEventListener(“animationfinish”,
        onAnimationFinish);
        viewer.openDzi(“OrionNebula.dzi”);
      }
      function show(msg) {
        var timeString = new Date( ).toLocaleTimeString( );
        output.innerHTML = msg + “ at ” + timeString + “.”;
      }
      function onOpen(viewer) {
        show(“Image opened”);
      }
      function onAnimationStart(viewer) {
        show(“Animation started”);
      }
      function onAnimationFinish(viewer) {
        show(“Animation finished”);
      }
      Seadragon.Utils.addEvent(window, “load”, init);
    </script>
    <style type=“text/css”>
      #container
      {
        width: 500px;
        height: 400px;
        background-color: black;
        border: 1px solid black;
        color: white; /* for error messages, etc. */
      }
      #outputHolder
      {
        width: 500px;
        height: 1em;
        margin-bottom: 1em;
        font-size: 125%;
      }
      #outputText
      {
        font-style: italic;
        font-weight: bold;
        margin-left: 0.5em;
      }
    </style>
  </head>
  <body>
    <div id=“outputHolder”>Last event: <span
id=“outputText”></span></div>
    <div id=“container”></div>
  </body>
</html>
```

An exemplary user interface displays an image and relies on Seadragon technology to navigate the image. In this example, the image includes individual first pages of patents and/or patent applications or so-called Blink documents, which may be presented in the form of a treemap. Upon zooming, the resolution of the individual pages increases to a legible level. A user may optionally pan and zoom to review a large number of patents or patent applications in a relatively short period of time. Noting that by zooming out, the treemap becomes visible, which can contain information as to, for example, class, patent scope, age, etc. In another example, the treemaps exist as blocks on the different countries of a country map to thereby allow for navigation around the map and zooming into a country or region to view patents, patent applications or so-called Blink document (e.g., summary documents).

As described herein, a dzi image or similar image changes based on changes in time according to a time control. Thus, a particular portfolio for a company may exist as a series of dzi images with respect to time where a user can select a time and navigate the image to view specific patent-related information. Where a user selects a different time, a different dzi image can appear, which is similarly navigable. Such a process can operate in near realtime given a database of the underlying dzi images. An exemplary method includes generating a series of dzi images for a patent portfolio of a company at specific time increments (e.g., one dzi image per month); storing the dzi images in a database and accessing a specific one of the dzi images based on a time control. According to the Seadragon technology, switching images is no different from opening them; just call the openDzi( )method. Sample code for switching images follows.

SAMPLE CODE

```
<!DOCTYPE html>
<html>
  <head>
    <script type=“text/javascript”
src=“http://seadragon.com/ajax/0.8/seadragon-min.js”></script>
    <script type=“text/javascript”>
      var viewer = null;
      function init( ) {
        viewer = new Seadragon.Viewer(“container”);
        viewer.openDzi(“BlueMarble.dzi”);
      }
      function switchTo(event, dzi) {
        if (dzi) {
          viewer.openDzi(dzi);
        } else {
          viewer.close( );
        }
        Seadragon.Utils.cancelEvent(event); // so links aren't processed
      }
      Seadragon.Utils.addEvent(window, “load”, init);
    </script>
    <style type=“text/css”>
      #container
      {
        width: 500px;
        height: 400px;
        background-color: black;
        border: 1px solid black;
        color: white; /* for error messages, etc. */
      }
    </style>
  </head>
  <body>
    <p>
      Show:
      <a href=“#” onclick=“switchTo(event, ‘BlueMarble.dzi’);”>Blue
Marble</a> /
      <a href=“#” onclick=“switchTo(event,
‘EarthCityLights.dzi’);”>Earth City Lights</a> /
      <a href=“#” onclick=“switchTo(event,
‘CarinaNebula.dzi’);”>Carina Nebula</a> /
      <a href=“#” onclick=“switchTo(event, ‘OrionNebula.dzi’);”>Orion
Nebula</a> /
      <a href=“#” onclick=“switchTo(event, null);”>(none)</a>
    </p>
    <div id=“container”></div>
  </body>
</html>
```

An exemplary treemap algorithm includes a constraint as to aspect ratio of a block where the aspect ratio pertains to an electronic document size (e.g., a first page of a patent or patent application or a summary of patent-related information as in a “blink”). The treemap algorithm then relies one or more specific criteria to generate the treemap with the constraint where area of a particular patent/patent application is controlled by the one or more criteria but the aspect ratio is controlled by document dimension/size. In an example, a treemap and documents are relied on to generate a dzi image file. Various dzi images can be created for a timeline and when a user selects a time, the appropriate dzi image is automatically loaded and zoomable. An exemplary method color codes documents by including a color that still allows for readability upon zooming while appearing more like a treemap at a distance with color coded elements (e.g., for highlighting terms, age, inventor, company, etc.).

In a particular example of a dzi image, an entire patent may be presented as a dzi image. The Seadragon technology and Photosynth technology (and Silverlight technology) may be relied on for visualization of patent information. A sample using Seadragon technology (also Deep Zoom technology) for pictures of music memorabilia can be found at http://memorabilia.hardrock.com/, which is incorporated by reference herein. This site includes a back end that uses Sharepoint technology for its content management and a front end in Silverlight technology. As described herein, Seadragon AJAX technology and/or Silverlight Deep Zoom can be used or other similar presentation frameworks. In various examples, collections of images may be used instead of a single image (e.g., in the treemap examples). Microsoft Corporation makes available Deep Zoom technology implemented in JavaScript using Ajax.

Another example includes an application called “40” http://www.vertigo.com/downloads/40/40.wmv, which allows for hover over of data points on a chart to display images associated with the data points.

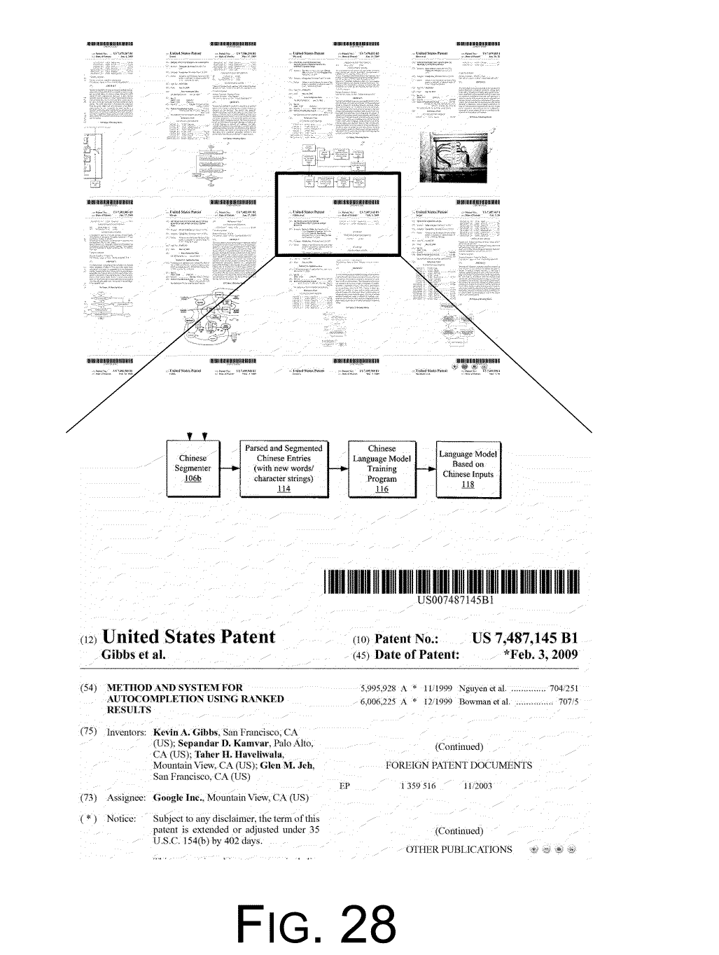

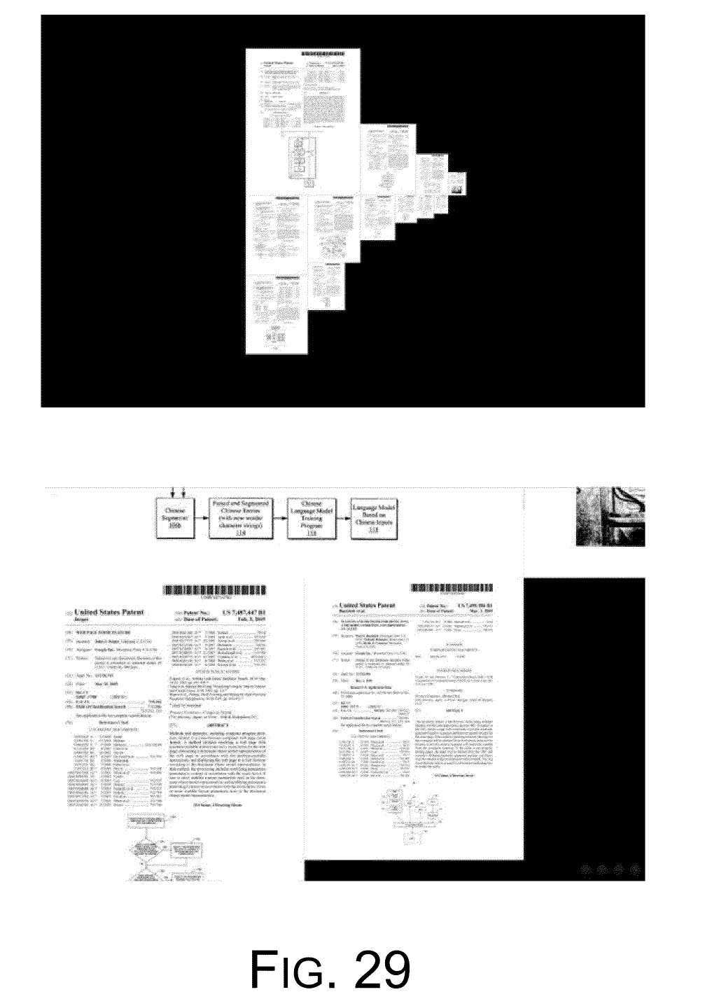

In a particular example, various tiff image files for Google patents were downloaded from the USPTO website. The Microsoft Deep Zoom composer application was used to import and compose a composite image for use with the deep zoom technology. Options exist for export of a composition for Seadragon technology and export for deep zoom technology. Both were tested and FIG. 28 corresponds to deep zoom and FIG. 29 corresponds to Seadragon. Shading or coloring of the images may be added without detracting from the readability of the text or graphics. For example, color coding may indicate age, ownership, inventorship, keywords in claims, etc. A composition may be in a treemap form or other form.

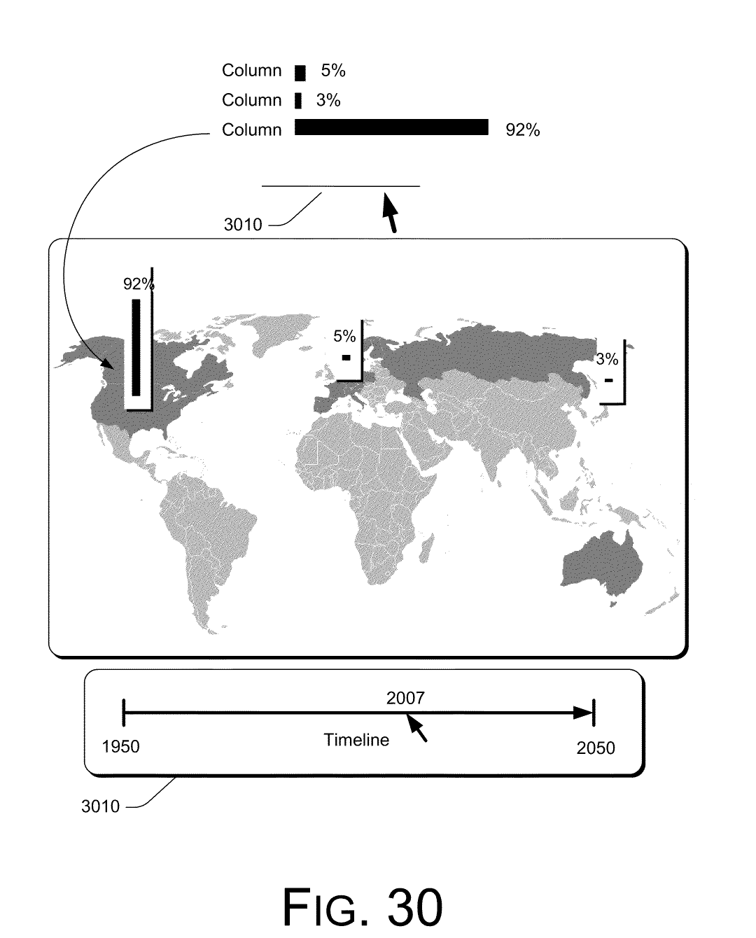

FIG. 30 is a diagram of an actual time slider 3010 with three rows or columns where the length of the column changes upon placement of a cursor over the timeline 3010, for example, according to the sample JavaScript code below. As described herein, for example, the columns may correspond to patents issued in different countries (example shown); patents issued to different assignees or inventors; expired patents, issued patents and patent applications; etc.

SAMPLE CODE:

```
<script language=JavaScript>
    // Element array constants used to identify positions in the array
    var TimeArrays = new Array( );
        TimeArrays[0] = new Array(‘1’, ‘1’, ‘63’);
        TimeArrays[1] = new Array(‘2’, ‘1’, ‘34’);
        TimeArrays[2] = new Array(‘3’, ‘5’, ‘34’);
        TimeArrays[3] = new Array(‘4’, ‘76’, ‘43’);
        TimeArrays[4] = new Array(‘6’, ‘14’, ‘43’);
        TimeArrays[5] = new Array(‘34’, ‘31’, ‘43’);
        TimeArrays[6] = new Array(‘5’, ‘71’, ‘37’);
        TimeArrays[7] = new Array(‘5’, ‘81’, ‘38’);
        TimeArrays[8] = new Array(‘9’, ‘51’, ‘36’);
        TimeArrays[9] = new Array(‘45’, ‘41’, ‘63’);
        TimeArrays[10] = new Array(‘34’, ‘31’, ‘63’);
        TimeArrays[11] = new Array(‘75’, ‘21’, ‘33’);
        TimeArrays[12] = new Array(‘2’, ‘61’, ‘43’);
        TimeArrays[13] = new Array(‘75’, ‘31’, ‘23’);
        TimeArrays[14] = new Array(‘34’, ‘11’, ‘63’);
        TimeArrays[15] = new Array(‘74’, ‘21’, ‘73’);
        TimeArrays[16] = new Array(‘23’, ‘31’, ‘93’);
        TimeArrays[17] = new Array(‘64’, ‘41’, ‘33’);
        TimeArrays[18] = new Array(‘76’, ‘51’, ‘23’);
        TimeArrays[19] = new Array(‘43’, ‘61’, ‘13’);
        TimeArrays[20] = new Array(‘12’, ‘71’, ‘3’);
        TimeArrays[21] = new Array(‘88’, ‘81’, ‘43’);
        TimeArrays[22] = new Array(‘13’, ‘91’, ‘43’);
        TimeArrays[23] = new Array(‘17’, ‘13’, ‘43’);
        TimeArrays[24] = new Array(‘75’, ‘12’, ‘36’);
        TimeArrays[25] = new Array(‘13’, ‘1’, ‘36’);
        function pregraph(lLoop){
            graphit(TimeArrays, 100, lLoop)
        }
</script>
<script language=“JavaScript1.2”>
//JavaScript Graph-it! (Absolute)- by javascriptkit.com
//Visit JavaScript Kit (http://javascriptkit.com) for script
//Credit intact for use
var graphimage=“poll.gif”
function graphit(g,gwidth,i){
total=0
for (w=0;w<g[i].length;w++)
total+=parseInt(g[i][w])
output=‘<table border=“0” cellspacing=“0” cellpadding=“0”>’
for (w=0;w<g[i].length;w++){
calpercentage=Math.round(g[i][w]*100/total)
calwidth=Math.round(gwidth*(calpercentage/100))
output+=‘<tr><td>Column&nbsp;</td><td><img src=“‘+graphimage+”’
width=“‘+calwidth+”’ height=“10”> ‘+calpercentage+’%</td></tr>’
}
output+=‘</table>’
ArrayLength = TimeArrays.length;
var oInp = new String( );
var lLoop = 0;
output += ‘<table border=0 align=left width=“100px” cellpadding=0
cellspacing=15px >’;
for (lLoop=0; lLoop<ArrayLength; lLoop++)
{
    output +=‘<a href=# style=“width:15px;height:30px;background:
url(bar.gif);” onmouseover=pregraph(‘ + lLoop + ’);>&nbsp;</a>’;
};
document.getElementById(‘hey’).innerHTML=output
}
//CALL GRAPHIT FUNCTION
//graphit(NAME OF GRAPH ARRAY, MAXIMUM WIDTH IN PIXELS)
</script>
<BODY onload=“pregraph(1);” >
<div id=“hey”>
</div>
</BODY>
```

In the foregoing sample code, the arrays are set. However, as described herein, the arrays may be populated by information from a search query. For example, if a search for Google patents was entered into the search area 2420 of FIG. 24 or the search area 2610 of FIG. 26, a database would be searched for patents assigned to Google. The information in the database would also include one or more time values such as issue date or filing date or age of the claim language based on the foregoing lexicon age determination. Given the search results, a user could manipulate a cursor with respect to the timeline control to thereby select a time or a time frame. In response, the search results would be analyzed to provide a metric such as a count (e.g., number of patents filed or issued prior to a selected date). This information would then be presented graphically on the map 2440 or 2640. As shown in FIG. 26, a user may select competitors of a company (e.g., Yahoo!). If the time criterion is issue date of issued patents, then as the user manipulated the time control, Yahoo! patents in the United State would show beginning in Nov. 9, 1999 (U.S. Pat. No. 5,983,227, filed Jun. 12, 1997) according to USPTO data and Google patents in the United States would show beginning in Feb. 25, 2003 (U.S. Pat. No. 6,526,440, filed Jan. 30, 2001) according to USPTO data. A user interface may include a control to switch between issue date and filing date. Given such an option, the filing date would show Yahoo! having earlier filed patent applications than Google. Such information and presentation options allow a user to quickly ascertain important aspects of companies that rely on patent protection.

As described herein, graphics may use columns, shadings of countries, circles, other shapes to convey information. In a particular example, company graphics are color coded (e.g., yellow for Yahoo! and orange for Google). Such a scheme allows a user to readily ascertain where and when patents were issued or patent applications filed for companies.

As the search area 2420 of FIG. 24 or the search area 2610 of FIG. 26 can be used for any of a variety of searches, colors and option boxes can be provided to distinguish various factors. For example, patents having inventors the oldest inventor older than 40 years of age at the time of filing patent applications may be represented by columns in green while those having the oldest inventor at or younger than 40 years of age may be represented in purple. Such factors may intersect with a search for “Google”. Accordingly, the age of oldest inventor on a patent may be ascertained. The time control then can allow for viewing the inventor age metric for the company to see whether it changes over time. Additional metrics may be presented in an area in a web page to readily ascertain averages of age or other information. With respect to age information, various databases are available and can be searched (e.g., including Linkedln and social networking databases or sites).

As described herein, a user interface that provides a search field (and optionally selection areas) along with a global map and a time line control provides for rich interaction with patent related data. Patent data is inherently jurisdiction specific and temporal. A global map provides for ascertaining “where” and a time control provides for ascertaining “when”. The search field provides for ascertaining “what”.

Various exemplary methods may be optionally embodied, in whole or in part, as instructions on a computer-readable medium.

What is claimed is:

1. One or more computer-readable media storing computer-executable instructions that, when executed, configure a processor to perform acts comprising:
querying an informational database for information about one or more intellectual property assets;
presenting a graphic on a display device, the graphic including a plurality of informational items that convey information regarding the one or more intellectual property assets; and
presenting an interface usable to configure the information items included in the graphic.

2. The one or more computer-readable media of claim 1, the interface being usable to configure a number and/or arrangement of the information items included in the graphic.

3. The one or more computer-readable media of claim 1, the interface comprising a menu of selectable information items for inclusion in the graphic.

4. The one or more computer-readable media of claim 1, the interface being usable to configure the graphic to include information items relating to an intellectual property portfolio of a company, information items relating to a patent portfolio of a company, and information items relating to an individual patent of a company.

5. The one or more computer-readable media of claim 1, the graphic comprising a scope information item that visually conveys how a scope of the one or more intellectual property assets changed during an administrative proceeding.

6. The one or more computer-readable media of claim 5, the graphic further comprising a timeline information item, the timeline information item including markings associated with dates in prosecution of the one or more intellectual property assets.

7. The one or more computer-readable media of claim 6, the one or more intellectual property assets including a patent, and the acts further comprising:
receiving selection of one of the markings of the timeline associated with a date in prosecution of the patent; and
presenting claim language of a claim of the patent as it existed on the date in prosecution.

8. The one or more computer-readable media of claim 1, the graphic comprising a clean/messy information item that visually conveys how many interactions occurred with an administrative agency with respect to the one or more intellectual property assets.

9. The one or more computer-readable media of claim 1, the one or more intellectual property assets comprising a patent, and the graphic comprising a word cloud information item displaying a cloud of words in a claim or claims of the patent along with an indication of a frequency that each word appears in the claim or claims of the patent and a frequency that each word appears in a specification of the patent.

10. The one or more computer-readable media of claim 9, the acts further comprising translating the cloud of words from one language into another language.

11. The one or more computer-readable media of claim 1, the graphic comprising a landscape analysis information item visually conveying information pertaining to how the one or more intellectual property assets fits within a technology field, a company's portfolio, one or more competitor portfolios, and/or a geographic field.

12. The one or more computer-readable media of claim 1, the graphic comprising a portfolio tree map visually conveying a relative scope and a relative age of the one or more intellectual property assets relative to one or more other intellectual property assets.

13. The one or more computer-readable media of claim 1, wherein the graphic includes a share price event information item including a stock chart showing historical stock performance of a company that owns the one or more intellectual property assets over a period of time, along with indicators showing legal events related to the one or more intellectual property assets over the period of time.

14. The one or more computer-readable media of claim 1, wherein the graphic includes a share price sensitivity information item comprising a visual indication of a sensitivity of a company's stock price to legal events related to the one or more intellectual property assets.

15. The one or more computer-readable media of claim 1, wherein the graphic includes a time slider usable to control display of information on the plurality of information items in a coordinated manner with respect to time.

16. The one or more computer-readable media of claim 15, wherein the time slider is usable to select a future time to visualize expiration of the one or more intellectual property assets.

17. The one or more computer-readable media of claim 15, wherein the time slider is movable to visualize characteristics of an intellectual property portfolio over time.

18. The one or more computer-readable media of claim 1, the graphic comprising:
a scope information item that visually conveys how a scope of the one or more intellectual property assets changed during an administrative proceeding;
a timeline information item, the timeline information item including markings associated with dates in prosecution of the one or more intellectual property assets;
a clean/messy information item that visually conveys how many interactions occurred with an administrative agency with respect to the one or more intellectual property assets;
a word cloud information item displaying a cloud of words in a claim or claims of a patent along with an indication of a frequency that each word appears in the claim or claims and a frequency that each word appears in a specification of the patent;
a portfolio tree map visually conveying a relative scope and a relative age of the one or more intellectual property assets relative to one or more other intellectual property assets;
a share price event information item including a stock chart showing historical stock performance of a company that owns the one or more intellectual property assets over a period of time, along with indicators showing legal events related to the one or more intellectual property assets over the period of time;
a share price sensitivity information item comprising a visual indication of a sensitivity of a company's stock price to patent litigation events; and
a time slider usable to control display of information on the plurality of information items in a coordinated manner with respect to time.

19. A computer-implemented method comprising:
presenting a graphic on a display device, the graphic including a plurality of informational items that convey information regarding one or more intellectual property assets; and
presenting an interface usable to configure the information items included in the graphic.

20. The computer-implemented method of claim 19, wherein the interface is usable to configure a number and/or arrangement of the information items included in the graphic.

21. The computer-implemented method of claim 19, wherein the interface comprises a menu of selectable information items for inclusion in the graphic.

22. The computer-implemented method of claim 19, wherein the interface is usable to configure the graphic to include information items relating to an intellectual property portfolio of a company, information items relating to a patent portfolio of a company, and information items relating to an individual patent of a company.

23. One or more computer-readable media storing computer-executable instructions that, when executed, configure a processor to perform acts comprising:
querying an informational database for information about a patent;
processing the information; and
presenting the processed information as a word cloud information item displaying a cloud of words in a claim or claims of the patent along with an indication of a frequency that each word appears in the claim or claims of the patent and a frequency that each word appears in a specification of the patent.

24. The one or more computer-readable media of claim 23, the processing comprising:
counting a frequency that each unique word appears in a claim or claims of the patent;
counting, for each word appearing in the claim or claims, a frequency that the word appears in the specification of the patent; and
assigning a relative size to each word in the claim or claims, based at least in part on a frequency that the word appears in the specification.

25. The one or more computer-readable media of claim 24, the processing further comprising assigning a color to each word in the claim or claims, based at least in part on whether the word appears in the specification.

26. The one or more computer-readable media of claim 24, the processing further comprising assigning a color to each word in the claim or claims, based at least in part on an age of the word in a lexicon of words.

27. One or more computer-readable media storing computer-executable instructions that, when executed, configure a processor to perform acts comprising:
querying an informational database for information about one or more intellectual property assets;
processing the information; and
presenting the processed information as a landscape analysis information item visually conveying information pertaining to how the one or more intellectual property assets fits within a technology field, a company's portfolio, one or more competitor portfolios, and/or a geographic field.

28. The one or more computer-readable media of claim 27, the landscape analysis information item including a portfolio tree map visually conveying a relative scope and a relative age of the one or more intellectual property assets relative to one or more other intellectual property assets.

29. The one or more computer-readable media of claim 28, the portfolio tree map comprising a plurality of blocks, each block corresponding to an individual intellectual property asset.

30. The one or more computer-readable media of claim 29, the acts further comprising:
receiving selection of a block of the portfolio tree map; and
displaying, in response to receiving the selection, an image of an intellectual property asset corresponding to the selected block of the portfolio tree map.

31. The one or more computer-readable media of claim 29, the displaying further comprising zooming in on the selected block to display the image of the intellectual property asset.
